(19) United States
(12) Patent Application Publication
(10) Pub. No.: US 2025/0337617 A1
(43) Pub. Date: Oct. 30, 2025

(54) SYSTEMS AND METHODS FOR SIGNAL GENERATION AND INFORMATION ESTIMATION WITH RECURRENT NEURAL NETWORKS

(71) Applicants: Taejoon Kim, Chandler, AZ (US); Purdue Research Foundation, West Lafayette, IN (US)

(72) Inventors: Christopher Greg Brinton, West Lafayette, IN (US); Junghoon Kim, West Lafayette, IN (US); Taejoon Kim, Chandler, AZ (US); David J. Love, West Lafayette, IN (US)

(73) Assignee: Purdue Research Foundation, West Lafayette, IN (US)

(21) Appl. No.: 19/187,832

(22) Filed: Apr. 23, 2025

Related U.S. Application Data
(60) Provisional application No. 63/638,261, filed on Apr. 24, 2024.

(51) Int. Cl. H04L 25/02; G06N 3/0455

(52) U.S. Cl. CPC H04L 25/0254; G06N 3/0455

(57) ABSTRACT

Systems and methods for communication between devices that leverage a family of non-linear feedback codes are disclosed, significantly enhancing robustness to channel noise. The systems and methods incorporate an autoencoder-based architecture designed to learn codes based on consecutive blocks of bits, which provides de-noising advantages over bit-by-bit processing to help overcome the physical separation between the encoder and decoder over a noisy channel. The autoencoder-based architecture includes a power control layer at the encoder to explicitly address hardware constraints within the learning optimization.

This application claims the benefit of priority of U.S. provisional application Ser. No. 63/638,261, filed on Apr. 24, 2024, the disclosure of which is herein incorporated by reference in its entirety.

### GOVERNMENT LICENSE RIGHTS

This invention was made with government support under CNS2146171, CNS2212565, CNS2225577, and ITE2226447 awarded by the National Science Foundation and with government support under N000142112472 awarded by the U.S. Navy Office of Naval Research. The government has certain rights in the invention.

### FIELD

The devices and methods disclosed in this document relate to signal generation and, more particularly, to signal generation and information estimation with recurrent neural networks.

### BACKGROUND

Unless otherwise indicated herein, the materials described in this section are not admitted to be the prior art by inclusion in this section.

The design of codes for channel coding has been an important field of research in information theory and communications, targeting efficient and reliable data transmission across a noisy channel. We now have near-optimal codes for the canonical open-loop additive white Gaussian noise (AWGN) channel setting, thanks to the extraordinary advancements in code design over several decades. However, the design of practical codes for a variety of other important channel models has remained a long-standing open problem. In particular, when feedback is available in communication systems, i.e., when a transmitter can obtain information on the received signals through a reverse link from a receiver, it has been shown that while capacity cannot be increased, communication reliability can be improved by utilizing feedback codes. However, the design of feedback codes is non-trivial since both the bit stream and feedback information (i.e., past receive signals) should be incorporated into the design. Though feedback codes hold the potential to revolutionize future communication systems, major innovations are needed in their design and implementation.

Linear Feedback Coding: Over several decades, research on the design of feedback codes for closed-loop AWGN channels mostly focused on the linear family of codes, which simplifies code design. The seminal work introduced a linear coding technique for AWGN channels with noiseless feedback, known as the SK scheme, which achieves doubly exponential decay in the probability of error. However, for noisy feedback, the SK scheme does not perform well. In response, a linear coding scheme for AWGN channels with noisy feedback was introduced, known as the CL scheme. The CL scheme was further examined and found to be optimal within the linear family of codes under the noisy feedback scenario. There have been attempts to view the linear feedback code design as feedback stabilization in control theory and dynamic programming. However, the linear assumption made in these works severely limits their ability to produce optimal codes.

Deep Learning-Based Channel Coding: A recent trend of research has been examining code design from a deep learning perspective to take advantage of its non-linear structure. Neural encoders and decoders have been shown to improve communication reliability and/or efficiency for various canonical channel settings, including open-loop AWGN channels. In the closed-loop AWGN channel case, Deepcode proposes an autoencoder architecture to generate non-linear feedback codes. Deepcode was shown to outperform SK and CL in terms of error performance across many noise scenarios due to the wider degree of flexibility that non-linearity provides for the creation of feedback codes. Deep extended feedback (DEF) codes generalize Deepcode by including parity symbols generated based on forward-channel output observations over longer time intervals and supporting high-order modulation in the encoder to maximize spectral efficiency. Generalized block attention feedback (GBAF) codes have recently been proposed with self-attention modules that can incorporate different neural network architectures. It has been shown that GBAF codes significantly outperform the existing solutions, especially in the noiseless feedback scenario.

Nevertheless, the vulnerability of these feedback codes to high forward/feedback noise remains understudied. High noise settings have become more pervasive as wireless networks have become denser, making reliable communications even more dependent on channel feedback. As pointed out in existing works, end-to-end learning for the design of codes over point-to-point channels benefits significantly from an autoencoder architecture's ability to jointly train the encoder and decoder.

Thus, it should be understood that the design of codes for feedback-enabled communications has been a long-standing open problem. Recent research on non-linear, deep learning-based coding schemes has demonstrated significant improvements in communication reliability over linear codes, but they are still vulnerable to the presence of forward and feedback noise over the channel.

Additionally, it should be appreciated that most of the modern communication systems, including cellular networks, Wi-Fi networks, satellite communications, and social media platforms, facilitate two-way interaction, enabling users to exchange messages in both directions. This interactive capability promotes a seamless exchange of information and feedback, supports real-time communication, and fosters effective collaboration among users. The input-output model that allows for the bidirectional exchange of information is referred to as a two-way channel. A practically relevant two-way channel model is the Gaussian two-way channel (GTWC), where Gaussian-distributed noise is added independently to each direction of the two-way channel between the users. Earlier studies on GTWCs have been mostly focused on analyzing the channel capacity region of GTWCs. Prior works have revealed that incorporating the previously received symbols (i.e., feedback information) into generating transmit symbols at the users does not increase the capacity of GTWCs. In other words, the channel capacity for GTWCs is achieved when the two-way channel is considered as two independent one-way channels, i.e., when two users do not cooperate with each other.

In addition to channel capacity, communication reliability or error probability is another important metric in information/communication theory. Currently, some researchers are focusing on examining GTWCs in terms of communication reliability. Prior works defined error exponents for GTWCs and showed how cooperation between the two users, or using previously received symbols in creating transmit symbols, can improve the error exponents in comparison to the non-cooperative case. Other works suggested a dynamic programming (DP)-based methodology for encoding to improve the communication reliability for GTWCs. Despite ongoing efforts to improve the communication reliability for GTWCs, the existing works still lack in providing a specific coding method and its performance evaluation under a finite block-length regime.

To the best of our knowledge, there is no framework for designing practical codes in GTWCs. A foundational coding strategy for GTWCs is to carry out linear processing for encoding and decoding in order to simplify the system model of GTWCs and mitigate the coding complexity. It is important to note that GTWCs can be thought of as an expanded system model of feedback-enabled Gaussian one-way channels (GOWCs), where a linear coding framework for GOWCs with feedback has been well developed. Prior works introduced a simple linear encoding for GOWCs that can achieve doubly exponential decay in the probability of error upon having noiseless feedback information. In other works, a general framework for linear coding was introduced, in which the noise may be colored, nonstationary, and correlated in GOWCs. In other works, a linear encoding scheme for GOWCs with noisy feedback was proposed, which is further analyzed and revealed to be an optimal structure under some conditions for linear encoding. There have been attempts to view the linear code design in feedback-enabled GOWCs as feedback stabilization in control theory and optimal DP. Overall, despite the availability of well-developed frameworks of linear coding for feedback-enabled GOWCs, such a linear framework has not been developed for GTWCs, which is one of the main motivations of this work. Linear processing offers the significant advantage of low complexity for encoding/decoding with a simplified system model. However, a significant limitation of linear coding is its inherent constraint on producing optimal codes because of the linearity.

It is important to note that there have also been research efforts on designing non-linear codes in feedback-enabled GOWCs. Along these lines, Deepcode, which exploits recurrent neural networks (RNNs) for non-linear coding in feedback-enabled GOWCs, shows performance improvements in the error probability across many noise scenarios as compared to linear coding. Other works have proposed deep extended feedback (DEF) codes that generalize Deepcode to improve the spectral efficiency and error performance. Further works proposed generalized block attention feedback (GBAF) codes that exploit self-attention modules to incorporate different neural network architectures. They showed that GBAF codes can outperform the existing solutions, especially in the noiseless feedback scenario.

### SUMMARY

A method for communicating between a first device and a second device is disclosed. The method includes generating a first transmit signal by encoding a first bit stream with a first processor of the first device, the first bit stream being encoded using a first neural network encoder. The method further includes transmitting, on a first communication channel, the first transmit signal to the second device with a first transmitter of the first device. The method further includes receiving, on the first communication channel, a first receive signal with a second receiver of the second device, the first receive signal corresponding to the first transmit signal with noise introduced in the first communication channel. The method further includes determining an estimation of the first bit stream by decoding the first receive signal with a second processor of the second device, the first receive signal being decoded using a second neural network decoder.

A method for transmitting data from a first device to a second device is disclosed. The method includes generating a first transmit signal by encoding a first bit stream with a processor of the first device, the first bit stream being encoded using a neural network encoder. The method further includes transmitting, on a first communication channel, the first transmit signal to the second device with a transmitter of the first device. The neural network encoder includes at least one recurrent neural network layer having a plurality of recurrent neural network cells in a forward arrangement, the plurality of recurrent neural network cells being configured to receive the first bit stream as input and output a state vector. The neural network encoder includes a non-linear neural network layer configured to receive the state vector, apply a linear operation to the state vector with a non-linear activation function, and output a scalar vector, the first transmit signal being determined at least in part based on the scalar vector.

A method for recovering data received with a second device from a first device is disclosed. The method includes receiving, on a first communication channel, a receive signal with a receiver of the second device, the receive signal corresponding to a first transmit signal transmitted by the first device with noise introduced in the first communication channel; and determining an estimation of a first bit stream by decoding the receive signal with a processor of the second device, the receive signal being decoded using a neural network decoder. The neural network decoder includes at least one recurrent neural network layer having a first plurality of recurrent neural network cells in a forward arrangement and a second plurality of recurrent neural network cells in a backward arrangement, the first plurality of recurrent neural network cells being configured to receive the receive signal as input and output a first state vector, the second plurality of recurrent neural network cells being configured to receive the receive signal as input and output a second state vector. The neural network decoder includes an attention layer configured to (i) receive the first state vector and the second state vector, (ii) determine an attention-processed first state vector based on the first state vector and first attention weights, and (iii) determine an attention-processed second state vector based on the second state vector and second attention weights. The neural network decoder includes a concatenation layer determines a combined state vector by concatenating the attention-processed first state vector and the attention-processed second state vector. The neural network decoder includes a second non-linear neural network layer configured to receive the combined state vector, apply a linear operation to the combined state vector with a non-linear activation function, and output the estimation of the first bit stream.

### BRIEF DESCRIPTION OF THE DRAWINGS

The foregoing aspects and other features of the systems and methods are explained in the following description, taken in connection with the accompanying drawings.

FIG. 1 shows a communication system comprising a first communication device and a second communication device.

FIG. 2 shows a logical flow diagram for a method for one-way communication between the first communication device and the second communication device.

FIG. 3 shows a canonical system model for one-way communication in an additive white Gaussian noise (AWGN) communication channel with noisy feedback.

FIG. 4 shows an encoder-decoder architecture for one-way communication between the first communication device and the second communication device.

FIG. 5 shows a compact version of the encoder-decoder architecture that omits detailed illustration of the timesteps seen in FIG. 4.

FIG. 6 shows pseudocode for an exemplary algorithm for training the proposed RNN autoencoder-based architecture.

FIG. 7 shows a logical flow diagram for a method for one-way communication between the first communication device and the second communication device.

FIG. 8 shows a canonical system model for two-way communication in an AWGN communication channel with noisy feedback.

FIG. 9 shows an encoder architecture for two-way communication between the first communication device and the second communication device.

FIG. 10 shows a decoder architecture for two-way communication between the first communication device and the second communication device.

FIG. 11 shows a compact version of an encoder-decoder architecture that omits detailed illustration of the timesteps seen in FIG. 9 and FIG. 10.

FIG. 12 shows pseudocode for an exemplary algorithm for training the proposed two-way coding architecture based on RNN autoencoder.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles of the disclosure as would normally occur to one skilled in the art to which this disclosure pertains.

### Overview of Communication System

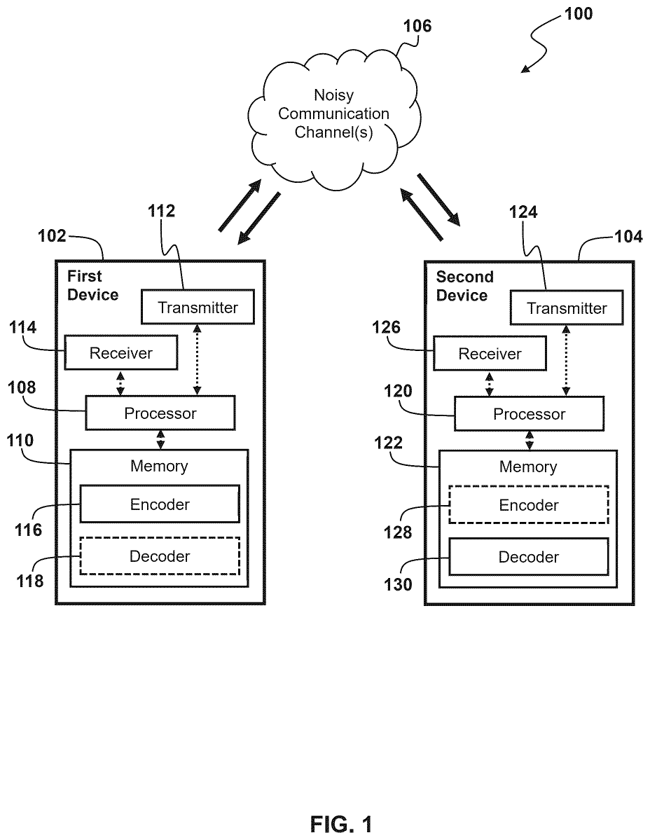

FIG. 1 shows a communication system 100 comprising a first communication device 102 (also referred to herein as the “User 1”) and a second communication device 104 (also referred to herein as the “User 2”). The first communication device 102 and the second communication device 104 communicate with one another via a noisy communication channel 106. The noisy communication channel 106 can include any communication medium that is subject to noise, including both wired and wireless. which is subject to noise. Noise in such communication channels may be caused by a variety of factors such as thermal fluctuations, interference, signal attenuation, environmental disturbances, hardware imperfections, and external sources, any of which can distort or degrade a transmitted signal.

In order to communicate reliably using the noisy communication channel 106, the first communication device 102 and the second communication device 104 are configured to leverage channel coding. Channel coding is used to improve the reliability of data transmission by adding redundant bits to the original data, allowing the receiver to detect and correct errors caused by noise in the communication channel. This process ensures that even if some parts of the data are corrupted during transmission, the original message can still be accurately reconstructed.

However, as discussed previously, conventional channel coding methods are subject to a variety of challenges. To overcome these challenges, the first communication device 102 and the 104 adopt a recurrent neural network (RNN) autoencoder-based architecture for power-constrained, feedback-enabled communications. To these ends, the first communication device 102 incorporates a neural network encoder 116 for encoding transmit signals based on a bit stream that is to be communicated to the second communication device 104. Likewise, the second communication device 104 incorporates a neural network decoder 130. The neural network encoder 116 and the neural network decoder 130 enable one-way coded communication from the first communication device 102 to the second communication device 104. However, in some embodiments, the second communication device 104 also incorporates a neural network encoder 128 and the first communication device 102 also incorporates a neural network decoder 118, thereby enabling two-way coded communication between the first communication device 102 and the second communication device 104.

In the illustrated exemplary embodiment, the first communication device 102 comprises a processor 108, memory 110, a transmitter 112, and a receiver 114. Similarly, the second communication device 104 comprises a processor 120, memory 122, a transmitter 124, and a receiver 126. Additionally, it will be recognized by those of ordinary skill in the art that a “processor” includes any hardware system, hardware mechanism, or hardware component that processes data, signals, or other information. The processors 108, 120 may include a system with a central processing unit, graphics processing units, multiple processing units, dedicated circuitry for achieving functionality, programmable logic, or other processing systems.

The memories 110, 122 are configured to store data and program instructions that, when executed by the respective processor 108, 120, enable the respective communication device 102, 104 to perform various operations described herein. The memories 110, 122 may be of any type of device capable of storing information accessible by the respective processor 108, 120, such as a memory card, ROM, RAM, hard drives, discs, flash memory, or any of various other computer-readable media serving as data storage devices, as will be recognized by those of ordinary skill in the art. The memory 110 of the first communication device 102 at least stores program instructions corresponding to the neural network encoder 116 and the neural network decoder 118, if applicable. Likewise, the memory 110 of the second communication device 104 at least stores program instructions corresponding to the neural network decoder 130 and the neural network encoder 128, if applicable.

The respective transmitters 112, 124 are each configured to convert transmit signals (i.e., data to be transmitted) into a signal suitable for transmission over the noisy communication channel 106, for example by modulation and/or encoding. The respective receivers 114, 126 are configured to capture the transmitted signal and convert the received signals into its original form, for example by demodulation and/or decoding. To these ends, the transmitters 112, 124 and the receivers 114, 126 may include antennas, amplifiers, oscillators, modulators, demodulators, or other hardware conventionally included transmitters and receivers.

### Methods for One-Way Communication Over an AWGN Channel

A variety of methods for one-way communication between the first communication device 102 and the second communication device 104 are discussed below. In the description of the method, statements that the method is performing some task or function refers to a controller or general-purpose processor (e.g., the processor 108 or the processor 120) executing programmed instructions stored in non-transitory computer readable storage media (e.g., the memory 110 or the memory 122) operatively connected to the controller or processor to manipulate data or to operate one or more components in the communication system 100 to perform the task or function. Additionally, the steps of the methods may be performed in any feasible chronological order, regardless of the order shown in the figures or the order in which the steps are described.

In this disclosure, a new family of non-linear feedback codes that greatly enhance robustness to channel noise are developed. Our autoencoder-based architecture is designed to learn codes based on consecutive blocks of bits, which obtains de-noising advantages over bit-by-bit processing to help overcome the physical separation between the encoder and decoder over a noisy channel. Moreover, we develop a power control layer at the encoder to explicitly incorporate hardware constraints into the learning optimization, and prove that the resulting average power constraint is satisfied asymptotically. It should be appreciated that high noise coding regimes pose two central challenges:

(1) Encoder-decoder mismatch: The encoder (as a transmitter) and decoder (as a receiver) are implemented on two separate platforms. Channel noise therefore causes mismatches in the latent space for coding between encoder and decoder which cannot be directly calibrated due to the limited bandwidth of the forward and feedback links. In Deepcode, the encoding structure consists of two distinct phases and operates bit-by-bit, which limits the size of the latent space available to build resilience against high noise conditions. In this work, we consider finite-length bit streams as the units for autoencoder learning to maximally benefit from noise averaging that forms the basis for error correction codes, and show the robustness of our codes to high noise levels.

(2) Inefficient power allocation: The transmitter has intrinsic hardware limitations which constrain the encoding outputs in terms of power across channel uses. Coding schemes for point-to-point channels without feedback exploit normalization at the encoding outputs to satisfy the power constraint. For power allocation in feedback-enabled channels, Deepcode employs two layers of power weights in addition to a normalization layer. However, none of these approaches account for the impact of channel noise on the efficacy of power allocation. In this work, we show how power control can be explicitly incorporated into the encoder optimization procedure to obtain constraint satisfaction guarantees.

We develop a recurrent neural network (RNN) autoencoder-based architecture for power-constrained, feedback-enabled communications. Using this architecture, we suggest a new class of non-linear feedback codes that build robustness to forward and feedback noise in AWGN channels with feedback.

Our learning architecture addresses the challenge of encoder-decoder separation over noisy channels by considering the entire bit stream as a single unit to potentially benefit from noise averaging, analogously to error correction codes. We also adopt a bi-directional attention-based decoding architecture to fully exploit correlations among noisy receive signals.

We augment our encoder architecture with a power control layer, which we prove satisfies power constraints asymptotically. We also provide information-theoretic insights on the power distribution obtained from our non-linear feedback codes, showing that power allocation is highest for early channel uses and then tapers off over time, similar to optimal linear codes.

While other feedback codes are vulnerable to high feedback noise, our codes still perform well as long as the forward noise is reasonable. Also, unlike existing codes, our methodology draws significant benefit from reductions in feedback noise even when the forward noise is high.

Additionally, we propose a modulo-based approach to extend our finite block length coding architecture to long block lengths. This provides computational scalability and generalization across different block lengths without requiring any re-training or parameter-tuning.

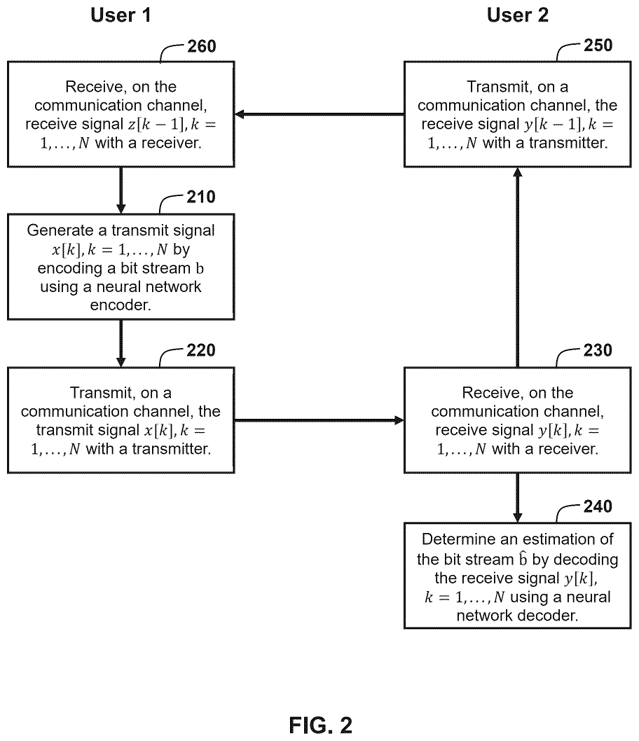

FIG. 2 shows a logical flow diagram for a method 200 for one-way communication between the first communication device 102 and the second communication device 104. At block 210, the processor 108 of the first communication device 102 (i.e., User 1) generates a transmit signal x[k], k=1, . . . , N by encoding a bit stream b using the neural network encoder 116, where N is the number of timesteps during which the first communication device 102 and the second communication device 104 communicate. Next, at block 220, the processor 108 operates the transmitter 112 to transmit, on a first communication channel, the transmit signal x[k], k=1, . . . , N to the second communication device 102. Next, at block 230, the processor 120 of the second communication device 104 (i.e., User 2) operates the receiver 126 to receive a receive signal y[k], k=1, . . . , N corresponding to the transmit signal x[k], k=1, . . . , N with noise introduced in the first communication channel. Next, at block 240, the processor 120 determines an estimation of the bit stream \hat{b} by decoding the receive signal y[k], k=1, . . . , N using the neural network decoder 130.

The method 200 also includes a feedback process in which, at block 250, the processor 120 of the second communication device 104 operates the transmitter 124 to transmit, on a second communication channel, a transmit signal y[k−1], k=1, . . . , N. In the one-way communication embodiments, the transmit signal y[k−1], k=1, . . . , N is the receive signal y[k], k=1, . . . , N delayed by one time step. Finally, at step 260, the processor 108 operates the receiver 114 to receive, on the second communication channel, a receive signal z[k−1], k=1, . . . , N corresponding to the transmit signal y[k−1], k=1, . . . , N with noise introduced in the second communication channel. Returning step 210, the processor 108 encodes the bit stream b based at least in part on receive signal z[k−1], k=1, . . . , N.

The technical details of the neural network architectures used to implement the method 200 are discussed in further detail below.

### 2. System Model and Optimization

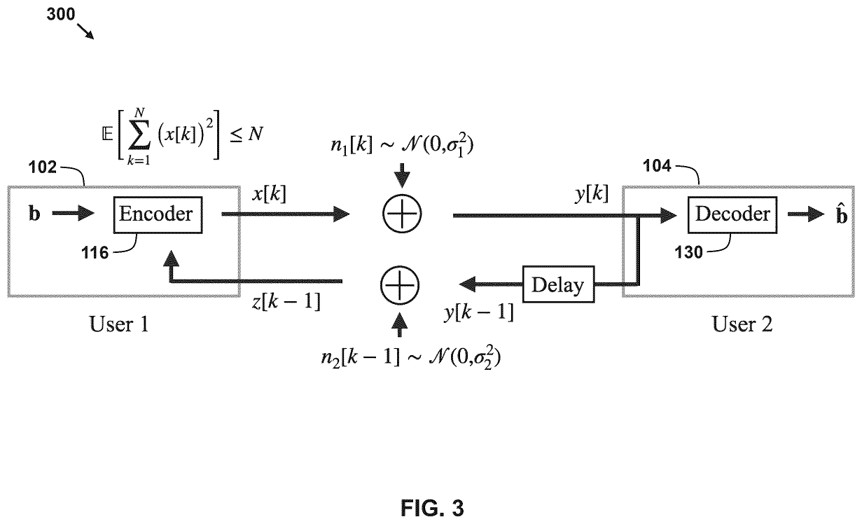

FIG. 3 shows a canonical system model 300 for one-way communication in an additive white Gaussian noise (AWGN) communication channel with noisy feedback. The goal is to successfully convey a message b from one device to another by exchanging transmit symbols x[k] between the users. The users employ encoders and decoders to ensure successful message transmissions.

### 2.1 Transmission Model

We assume that the transmission occurs over N channel uses (timesteps). Let k∈{1, . . . , N} denote the index of channel use and x[k]∈ [symbol] represent the transmit signal at time k. At time k, the second communication device 104 receives the signal

$$y [ k ] = x [ k ] + {n}_{1} [ k ] ∈ ℝ , k = 1 , … , N , \qquad ( 1 - 1 )$$

where

$${n}_{1} [ k ] ∼ 𝒩 ( 0 , {σ}_{1}^{2} )$$

is Gaussian noise for the forward channel. We consider an average power constraint as

$$𝔼 [ {\sum }_{k = 1}^{N} {( x [ k ] )}^{2} ] \leq N . \qquad ( 2 - 1 )$$

At each time k, the second communication device 104 feeds back the receive signal y[k] to the first communication device 102 over a noisy feedback channel, as shown in FIG. 3. The first communication device 102 then receives

$$z [ k ] = y [ k ] + {n}_{2} [ k ] , k = 1 , … , N , \qquad ( 3 - 1 )$$

where

$${n}_{2} [ k ] ∼ 𝒩 ( 0 , {σ}_{2}^{2} )$$

is the feedback noise.

### 2.2 Functional Form of Encoding and Decoding

The goal of the transmission is to successfully deliver a bit stream b∈{0,1}^{K} from the first communication device 102 to the second communication device 104 over a noisy channel, where K is the number of source bits. For efficient communication of b, we consider the following encoding and decoding procedures.

Encoding. The first communication device 102 encodes the bit stream b∈{0,1}^{K} to generate the transmit signals of N channel uses, i.e.,

$${\{ {x}_{i} [ k ] \}}_{k = 1}^{N} .$$

The coding rate is defined by r=K/N. Provided feedback from the second communication device 104, the encoding at the first communication device 102 is described as a function of the bit stream b and the feedback signals

$${\{ z [ j ] \}}_{j = 1}^{k - 1}$$

in equation (3-1). Defining an encoding function at time k as fₖ: [symbol] ^{K+k-1}→ [symbol] , we represent the encoding at time k as

$$x [ k ] = {f}_{k} ( b , z [ 1 ] , … , z [ k - 1 ] ) , k = 1 , … , N . \qquad ( 4 - 1 )$$

Decoding. Once the N transmissions are completed, the second communication device 104 decodes the receive signals of N channel uses, i.e.,

$${\{ y [ k ] \}}_{k = 1}^{N}$$

in equation (1-1), to obtain an estimate of the bit stream, \hat{b}∈{0,1}^{K}. Define a decoding function as g: [symbol] ^{N}→{0,1}^{K}. Then, we represent the decoding process conducted by the second communication device 104 as

$$\hat{b} = g ( y [ 1 ] , … , y [ N ] ) . \qquad ( 5 - 1 )$$

### 2.3 Optimization for Encoder and Decoder

Block error rate (BLER), the ratio of the number of incorrect bit streams to the total number of bit streams, is commonly used as a performance metric to assess the communication reliability of bit stream transmissions. Formally, with BLER defined as Pr[b≠\hat{b}], we consider our encoder-decoder design objective to be the following optimization problem:

$${minimize}_{{f}_{1} , … , {f}_{N} , g} Pr [ b \neq \hat{b} ] \qquad ( 6 - 1 )$$

$$subject to {𝔼}_{b , {n}_{1} , {n}_{2}} [ {\sum }_{k = 1}^{N} {( x [ k ] )}^{2} ] \leq N \qquad ( 7 - 1 )$$

The expectation in equation (7-1) is taken over the distributions of the bit stream b and the noises, n₁ and n₂, since the encoding output x[k] depends on b, n₁ and n₂ in (4-1), where n₁=[n₁[1], . . . , n₁[N]]^{T} and n₂=[n₂[1], . . . , n₂[N]]^{T}.

Thus, the goal is to optimize N encoding functions

$${\{ {f}_{k} \}}_{k = 1}^{N}$$

and a decoding function g. However, the complexity of designing N encoding functions increases to a great extent with the number of channel uses N. To mitigate the associated design complexity, we introduce a state propagation-based encoding technique, discussed next.

### 2.4 State Propagation-Based Encoding

Given that the inputs used for encoding at each time in equation (4-1) are overlapping, we expect that the N encoding functions are correlated with one another. As a result, we consider a state propagation-based encoding technique where the encoding is performed at each timestep using only two distinct functions: (i) signal-generation and (ii) state-propagation.

Defining the signal-generation function as f: [symbol] ^{K+N}^{ₛ}⁻¹→ [symbol] , we re-write the encoding process in equation (4-1) as

$$x [ k ] = f ( b , z [ k - 1 ] , s [ k ] ) , k = 1 , ... , N . \qquad ( 8 - 1 )$$

where we assume z[−1]=0. Here, s[k]∈ [symbol] ^{N}^{ₛ} is the state vector, which propagates over time through the state-propagation function h: [symbol] ^{K+N}^{ₛ}⁺¹→ [symbol] ^{N}^{ₛ}, given by

$$s [ k ] = h ( b , z [ k - 1 ] , s [ k - 1 ] ) , k = 1 , ... , N . \qquad ( 9 - 1 )$$

Note that, in equation (9-1), the current state s[k] is updated from the prior state s[k−1] by incorporating b and z[k−1]. For the initial condition, we assume s[−1]=0. This encoding model in equations (8-1)-(9-1) can be seen as a general and non-linear extension of the state-space model used for linear encoding in feedback systems.

Through this technique, we only need to design the two encoding functions, f and h—instead of N separate functions—and the decoding function g. We thus re-write the optimization problem in equations (6-1)-(7-1) as

$${minimize}_{f , h , g} Pr [ b \neq \hat{b} ] \qquad ( 10 - 1 )$$

$$subject to {𝔼}_{b , {n}_{1} , {n}_{2}} [ {\sum }_{k = 1}^{N} {( x [ k ] )}^{2} ] \leq N \qquad ( 11 - 1 )$$

Nevertheless, the problem of equations (10-1)-(11-1) is non-trivial since the functions f, h, and g can take arbitrary forms. Over several decades of research in the design of such functions, a linear assumption was made. While omitting low-complexity schemes, this constrains the degree of freedom in the design of such functions, leading to unsatisfactory error performances. We next employ this state propagation-based encoding in the design of non-linear feedback codes that are robust to channel noise.

### 3. Feedback Coding Methodology

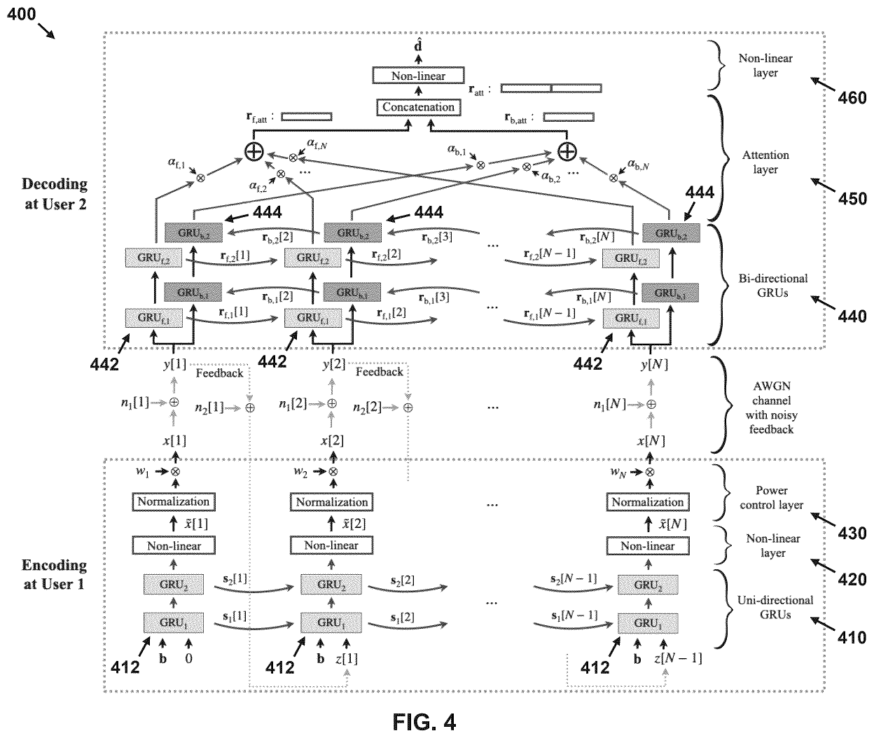

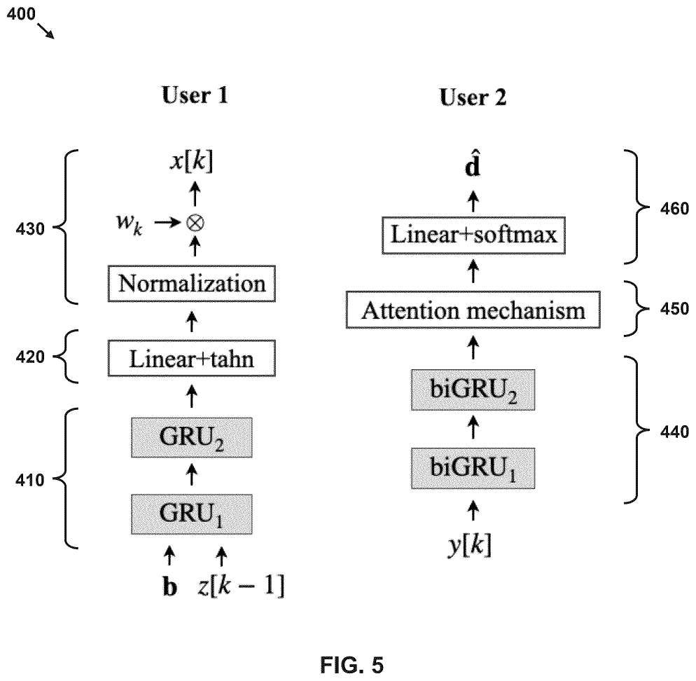

FIG. 4 shows an encoder-decoder architecture 400 for one-way communication between the first communication device 102 and the second communication device 104. The architecture 400 follows an RNN autoencoder-based architecture for non-linear coding over an AWGN channel with noisy feedback. The encoder-decoder architecture 400 includes the neural network encoder 116 and the neural network decoder 130. In the encoder-decoder architecture 400, the neural network encoder 116 includes at least one recurrent neural network layer 410, a non-linear neural network layer 420, and at least one power control neural network layer 430. Additionally, in the encoder-decoder architecture 400, the neural network decoder 130 includes at least one recurrent neural network layer 440, an attention layer 450, and a non-linear neural network layer 460. At the end of the decoding process, \hat{d} denotes a probability distribution of the 2^{K} possible outcomes of the bit stream estimate \hat{b}. The neural network encoder 116 and neural network decoder 130 are present at the first communication device 102 and second communication device 104, respectively, under the framework of autoencoder architectures. The transmit signal x[k] travels through the AWGN channel, and the noisy version of x[k], i.e., y[k], is provided as an input to the decoder and also transmitted back to the neural network encoder 116. Our goal with this RNN autoencoder-based structure is to jointly train the encoder and decoder. FIG. 5 shows a compact version of the encoder-decoder architecture 400 that omits detailed illustration of the timesteps seen in FIG. 4.

### 3.1 Encoding

We follow the state propagation-based encoding approach discussed in Section 2.4. The state-propagation function h in equation (9-1) consists of two layers of gated recurrent units (GRUs), while the signal-generation function f in equation (8-1) consists of a non-linear layer and a power control layer in sequence.

GRUs for state propagation. The at least one recurrent neural network layer 410 has a plurality of recurrent neural network cells 412 in a forward arrangement. In the illustrated embodiment, each recurrent neural network cell 412 is a gated recurrent unit (GRU) cell. However, it should be appreciated that other types of cells may be utilized, such as Long Short-Term Memory (LSTM) cells. The plurality of recurrent neural network cells 412 are configured to receive the bit stream b and the feedback receive signal z[k−1] as input. The plurality of recurrent neural network cells 412 are configured to output a final state vector based on the bit stream b and the feedback receive signal z[k−1].

Particularly, at each time step, the following procedure is conducted for a total of N time steps, where N transmit signals are generated for transmission over the N channel uses. First, the input to the first layer of the forward recurrent neural network cells 412 is the K bits of the bit stream b, the previous receive signal z[k−1] (from feedback from the second communication device 104 to the first communication device 102), and the previous state vector of the first layer of the forward recurrent neural network cells 412, and the output from the first layer is the current state vector of the first layer. Next, the input to the second layer is the current state vector of the first layer and the previous state vector of the second layer, and the output from the second layer is the current state vector of the second layer. If more than two layers are considered, the rest of the layers higher than the second layer follows the same steps for the second layer as described as above. Finally, the output of the last layer of the forward recurrent neural network cells 412 is the final state vector that is used as input to the non-linear neural network layer 420.

In one embodiment, we adopt two layers of unidirectional GRUs to capture the time correlation of the feedback signals in a causal manner. Formally, we represent the input-output relationship at each layer at time k as

$${s}_{1} [ k ] = {GRU}_{1} ( b , z [ k - 1 ] , {s}_{1} [ k - 1 ] ) , \qquad ( 12 - 1 )$$

$${s}_{2} [ k ] = {GRU}_{2} ( {s}_{1} [ k - 1 ] , {s}_{2} [ k - 1 ] ) , \qquad ( 13 - 1 )$$

where GRUᵢ represents a functional form of GRU processing at layer i and sᵢ[k]∈ [symbol] ^{N}^{_{s,t}} is the state vector obtained by GRUᵢ at time k, where i=1, 2 and k=1, . . . , N. For the initial conditions, we assume sᵢ[−1]=0, i=1, 2.

Equations (12-1)-(13-1) can be represented as a functional form of the state propagation-based encoding in equation (9-1). By defining the overall state vector as s[k]=[s₁[k], s₂[k]], we obtain s[k]=h(b, z[k−1], s[k−1]), where h implies the process of two layers of GRUs in equations (12-1)-(13-1). Note that s[k] propagates over time through the GRUs by incorporating the current input information into its state. Because the bit stream b with length K is handled as a block to generate transmit signals with any length N, our method is flexible enough to support any coding rate r, unlike the prior approach that only appears to support r=1/3.

Non-linear layer. The non-linear neural network layer 420 is configured to receive the final state vector from the at least one recurrent neural network layer 410, apply a linear operation to the first state vector with a non-linear activation function, and output a scalar vector \tilde{x}[k]. Particularly, at each time step, the following procedure is conducted for a total of N time steps, where N transmit signals are generated for transmission over the N channel uses. First, the input to the non-linear neural network layer 420 is the final state vector obtained from one or more layers of forward recurrent neural network cells 412. The input undergoes linear processing, wherein a vector input is multiplied by a trainable weight vector wₑ using an inner product operation, followed by adding a trainable scalar bias value bₑ to the outcome of the inner product. The scalar value after the linear processing goes through a non-linear activation function, e.g., hyperbolic tangent, resulting in another scalar value \tilde{x}[k] as an output.

Formally, we can represent the process of the non-linear neural network layer 420 as

$$\begin{matrix}\tilde{x} [ k ] = ϕ ( {w}_{e}^{T} {s}_{2} [ k ] + {b}_{e} ) & k = 1 , ... , N\end{matrix} , \qquad ( 14 - 1 )$$

where wₑ∈ [symbol] ^{N}^{_{s,2}} and bₑ∈ [symbol] are the trainable weights and biases, respectively, and ϕ: [symbol] → [symbol] is a non-linear activation function (e.g., hyperbolic tangent).

It is possible to use \tilde{x}[k] directly as a transmit signal, since \tilde{x}[k] ranges in (−1, 1) and satisfies the power constraint

$${\sum }_{k = 1}^{N} {( \tilde{x} [ k ] )}^{2} \leq N .$$

However, this does not ensure maximum utilization of the transmit power budget. Power control over the sequence of transmit signals is essential in the design of encoding schemes for feedback-enabled communications in order to achieve robust error performance.

Power control layer. The at least one power control neural network layer 430 is configured to receive the scalar vector \tilde{x}[k], multiply the scalar vector \tilde{x}[k] with a weights vector wₖ, and output the transmit signal x[k]. Particularly, at each time step, the following procedure is conducted for a total of N time steps, where N transmit signals are generated for transmission over the N channel uses. First, the scalar vector \tilde{x}[k] obtained from the non-linear neural network layer 420 serves as the input, which then undergoes normalization comprising subtracting the sample mean and dividing by the sample variance, both of which are trainable. Subsequently, the normalized value is multiplied by a trainable scalar weights vector wₖ.

The at least one power control neural network layer 430 thus consists of two consecutive modules: (i) normalization and (ii) power-weight multiplication. The transmit signal at time k is then generated by

$$x [ k ] = {w}_{k} {γ}_{k}^{( J )} ( \tilde{x} [ k ] ) , k = 1 , ... , N , \qquad ( 15 - 1 )$$

where

$${γ}_{k}^{( J )} : ℝ \to ℝ$$

is a normalization function applied to \tilde{x}[k], which consists of the sample mean and sample variance calculated from the data with size J. Here, wₖ is a trainable power weight satisfying

$${\sum }_{k = 1}^{N} {w}_{k}^{2} = N .$$

The at least one power control neural network layer 430 is configured to optimize for the power distribution, while also satisfying the power constraint in equation (11-1). Particularly, the weights vector wₖ is learned during a training of the neural network encoder 116 such that the transmit signal x[k] satisfy an average power constraint of the transmitter 112 of the first communication device 102, ensuring effective power control of the transmit signals.

Through the power control layer, the power weights are optimized via training in a way that minimizes the BLER in equation (10-1). At the same time, the power constraint in equation (11-1) should be satisfied. To obtain a smaller BLER, it is advantageous to ensure maximum utilization of the power budget N. However, satisfying the power constraint in an (ensemble) average sense is non-trivial, since the distributions of

$${\{ x [ k ] \}}_{k = 1}^{N}$$

are unknown. Therefore, we approach it in an empirical sense: (i) During training, we use standard batch normalization; we normalize \tilde{x}[k] with the sample mean and sample variance calculated from each batch of data (with size N_{batch}) at each k. (ii) After training, we calculate and save the sample mean and sample variance from the entire training data (with size J). (iii) For inference, we use the saved mean and variance for normalization.

In the following lemma, we show that the above procedure guarantees satisfaction of the equality power constraint in an asymptotic sense with a large number of training data used for normalization.

Lemma 1. Given the power control layer in equation (15-1), the power constraint in equation (11-1) converges to N almost surely, i.e.,

$${𝔼}_{b , {n}_{1} , {n}_{2}} [ {\sum }_{k = 1}^{N} {( x [ k ] )}^{2} ] {\to }^{a . s .} N ,$$

as the number of training data J used for normalization tends to infinity.

Remark 1. Because of the data-dependent normalization in generating x[k] in equation (15-1),

$${𝔼}_{b , {n}_{1} , {n}_{2}} [ {\sum }_{k = 1}^{N} {( x [ k ] )}^{2} ]$$

a random sequence along J in our implementation. We note that our neural network builds resiliency to the small size of inference data by using the saved mean and variance (rather than calculating them with the batch of inference data).

### 3.2 Decoding

With continued reference to FIG. 4, our decoding function g consists of the at least one recurrent neural network layer 440, the attention layer 450, and the non-linear neural network layer 460. We discuss each of them in detail below.

Bi-directional GRU. The at least one recurrent neural network layer 440 has a plurality of recurrent neural network cells 442 in a forward arrangement and a plurality of recurrent neural network cells 444 in a backward arrangement. In the illustrated embodiment, each recurrent neural network cell 442, 444 is a gated recurrent unit (GRU) cell. However, it should be appreciated that other types of cells may be utilized, such as Long Short-Term Memory (LSTM) cells. The plurality of recurrent neural network cells 442 are configured to receive the receive signal y[k] as input and output a final forward state vector. The plurality of recurrent neural network cells 444 are configured to receive the receive signal y[k] as input and output a final backward state vector.

Particularly, at each time step, the following procedure is conducted for a total of N time steps, where N transmit signals are generated for transmission over the N channel uses. First, the input to the first layer of the forward recurrent neural network cells 442 is the current receive signal y[k] and previous state vector of the first layer of the forward recurrent neural network cells 442, and the output is the current state vector of the first layer of the forward recurrent neural network cells 442. The input to the first layer of the backward recurrent neural network cells 444 is the current receive signal y[k] and the next-step state vector of the first layer of the backward recurrent neural network cells 444, and the output is the current state vector of the first layer of the backward recurrent neural network cells 444. Next, the input to the second layer of the forward recurrent neural network cells 442 is the current state vector of the first layer of the forward recurrent neural network cells 442 and the previous state vector of the second layer of the forward recurrent neural network cells 442. The input to the second layer of the backward recurrent neural network cells 444 is the current state vector of the first layer of the backward recurrent neural network cells 444 and the next-step state vector of the second layer of the backward recurrent neural network cells 444. If more than two layers are considered, the rest of the layers higher than the second layer follows the same steps for the second layer as described as above. The output of the last layer of the forward recurrent neural network cells 442 and backward recurrent neural network cells 444 are the final forward state vector and the final backward state vector, respectively.

In the illustrated embodiment, we utilize two layers of bi-directional GRUs to capture the time correlation of the receive signals both in the forward and backward directions. We represent the input-output relationship of the forward directional GRUs at time k as

$${r}_{f , 1} [ k ] = {GRU}_{f , 1} ( y [ k ] , {r}_{f , 1} [ k - 1 ] ) , \qquad ( 16 - 1 )$$

$${r}_{f , 2} [ k ] = {GRU}_{f , 2} ( {r}_{f , 1} [ k ] , {r}_{f , 2} [ k - 1 ] ) ,$$

and that of the backward directional GRUs as

$${r}_{b , 1} [ k ] = {GRU}_{b , 1} ( y [ k ] , {r}_{b , 1} [ k + 1 ] ) , \qquad ( 17 - 1 )$$

$${r}_{b , 2} [ k ] = {GRU}_{b , 2} ( {r}_{b , 1} [ k ] , {r}_{b , 2} [ k + 1 ] ) ,$$

where GRU_{f,i} and GRU_{b,i} represent functional forms of GRU at layer i in the forward and backward direction, respectively. Here, r_{f,i}[k]∈ [symbol] ^{N}^{_{r,i}} and r_{b,i}[k]∈ [symbol] ^{N}^{_{r,i}} are the state vectors obtained by GRU_{f,i} and GRU_{b,i}, respectively, at time k, where i=1, 2 and k=1, . . . , N. For the initial conditions, r_{f,i}[−1]=0 and r_{b,i}[N+1]=0, i=1, 2.

Attention layer. The attention layer 450 is configured to receive the final forward state vector and the final backward state vector from the at least one recurrent neural network layer 440. Next, the attention layer 450 determines an attention-processed forward state vector r_{f,att} based on the final forward state vector and forward attention weights α_{f,k}. Likewise, the attention layer 450 determines an attention-processed backward state vector r_{b,att} based on the final backward state vector and backward attention weights α_{b,k}.

Particularly, at each time step, the following procedure is conducted for a total of N time steps, where N transmit signals are generated for transmission over the N channel uses. First, the input to the attention layer 450 is the final N forward state vectors and the final N backward state vectors, both of which are obtained over the N time steps. Next, the final N forward state vectors are multiplied by trainable forward attention weights α_{f,k} and then summed to produce an attention-processed forward state vector r_{f,att} as an output. The final N backward state vectors are multiplied by trainable backward attention weights α_{b,k} and then summed to produce an attention-processed backward state vector r_{b,att} as an output.

We consider the state vectors at the last layer, i.e., r_{f,2}[k] and r_{b,2}[k], over k=1, . . . , N, as inputs to the attention layer. Each state vector contains different feature information depending on both its direction and time-step k: The forward state vector r_{f,2}[k] captures the implicit correlation information of the receive signals of y[1], . . . , y[k], while the backward state vector r_{b,2}[k] captures that of y[k], . . . , y[N], k=1, . . . , N. Although the state vectors at each end, i.e., r_{f,2}[k] and r_{b,2}[k], contain the information of all receive signals, the long-term dependency cannot be fully captured. Therefore, we adopt the attention layer. Formally,

$${r}_{f , att} = {\sum }_{k = 1}^{N} {α}_{f , k} {r}_{f , 2} [ k ] , {r}_{b , att} = {\sum }_{k = 1}^{N} {α}_{b , k} {r}_{b , 2} [ k ] , \qquad ( 18 - 1 )$$

where α_{f,k}∈ [symbol] and α_{b,k}∈ [symbol] are the trainable attention weights applied to the forward and backward state vectors, respectively, k=1, . . . , N.

Next, a concatenation layer determines a combined state vector rₐₜₜ by concatenating the attention-processed forward state vector r_{f,att} and attention-processed backward state vector r_{b,att}. In other words, to capture the forward and backward directional information separately, we concatenate the two vectors, leading to

$${r}_{att} = [ {r}_{f , att} ; {r}_{b , att} ] . \qquad ( 19 - 1 )$$

In this separated encoder-decoder architecture, the attention mechanism at the decoder enables the decoder to fully exploit the noisy signal information

$${\{ y [ k ] \}}_{k = 1}^{N} .$$

Non-linear layer. The non-linear neural network layer 460 is configured to receive the combined state vector rₐₜₜ. Next, the non-linear neural network layer 460 applies a linear operation to the combined state vector rₐₜₜ With a non-linear activation function and outputs the estimation of the bit stream \hat{b}. Particularly, the single combined state vector is multiplied with a trainable weight matrix W_{d} and then added to a trainable bias vector v_{d}, resulting in an output vector with length M. Next, for M=2^{K}, the output vector goes through a softmax function, resulting in an output that is the probability distribution of 2^{K} possible outcomes of the bit stream with length K, ensuring block-wise processing. Finally, for M=K, the output vector goes through a sigmoid function, resulting in an output where each entry of the output vector denotes the probability of the binary outcome between 0 or 1 of each bit, ensuring bit-wise processing.

At the end of the decoder, we utilize a non-linear layer to finally obtain the estimate \hat{b} by using the combined state vector rₐₜₜ in equation (19-1). The input-output relationship at the non-linear layer is given by

$$\hat{d} = θ ( {W}_{d} {r}_{att} + {v}_{d} ) \qquad ( 20 - 1 )$$

where θ: [symbol] ^{2N}^{_{r,2}}→ [symbol] ^{M} is an activation function, and W_{d}∈ [symbol] ^{M×2N}^{_{r,2}} and v_{d}∈ [symbol] ^{M} are the trainable weights and biases, respectively. In this work, we consider softmax function for θ and set to M=2^{K}. Then, \hat{d}∈ [symbol] ²^{^{K}} denotes the probability distribution of 2^{K} possible outcomes of \hat{b}.

Model training and inference. For training, we consider the cross entropy

$$( C E ) loss C E ( d , \hat{d} ) = - {\sum }_{i = 1}^{{2}^{K}} {d}_{i} log {\hat{d}}_{i} ,$$

where d∈{0,1}²^{^{K}} is the one-hot representation of b∈{0,1}^{K}, and dᵢ and \hat{d}ᵢ are the i-th entry of d and \hat{d}, respectively. For inference, we force the entry with the largest value of \hat{d} to 1, while setting the rest entries to 0, and then map the obtained one-hot vector to a bit stream vector \hat{b}. By treating the entire bit stream as a block through the use of one-hot vectors, we transform our problem of minimizing BLER, i.e., Pr[b≠\hat{b}] in equation (10-1), into a classification problem.

Thus, for M=2^{K}, which corresponds to block-wise processing, the entry with the largest value is converted to have an output of 1, while the rest of the entries are converted to 0, resulting in a one-hot vector where only 1 non-zero value in the 2^{K}-length vector. In such embodiments, the processor 120 decodes the receive signal y[k] to determine the one-hot vector \hat{d} having only a single non-zero value and the processor 120 determines the estimation of a bit stream \hat{b} as the single non-zero value from the one-hot vector \hat{d}. The one-hot vector is mapped to a bit stream vector of length K, which is the final recovered K bits.

Alternatively, for M=K, which corresponds to bit-wise processing, if each entry's value is larger than 0.5, the value is mapped to 1, otherwise 0, resulting in a K-length binary vector, which is the final recovered K bits of the estimation of a bit stream \hat{b}.

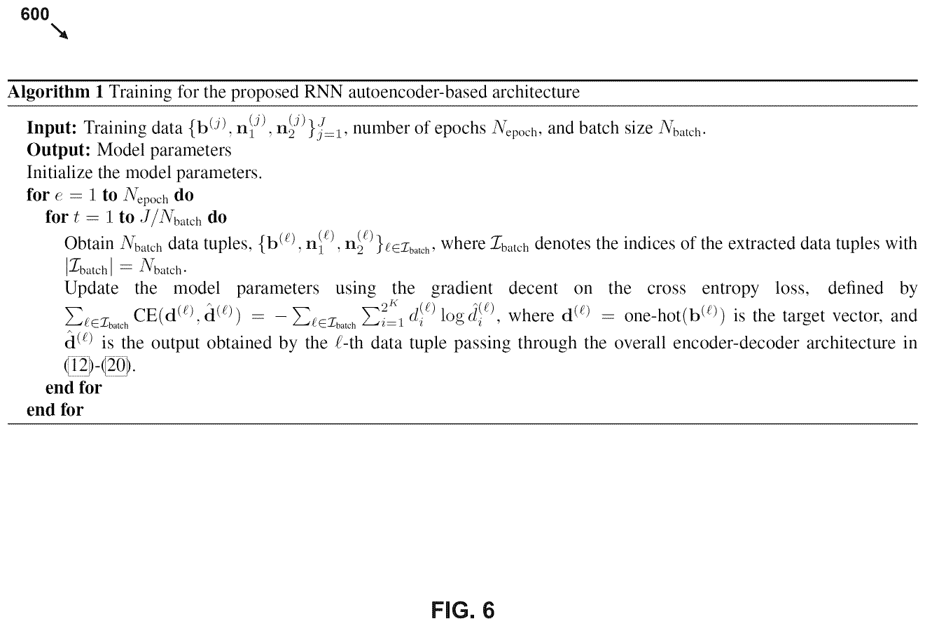

FIG. 6 shows pseudocode 600 for an exemplary algorithm for training the proposed RNN autoencoder-based architecture. The number of training data is J=10⁷, the batch size is N_{batch}=2.5×10⁴, and the number of epochs is N_{epoch}=300. We use the A dam optimizer and a decaying learning rate, where the initial rate is 0.01 and the decaying ratio is γ=0.95 applied for every epoch. We also use gradient clipping for training, where the gradients are clipped when the norm of gradients is larger than 1. We adopt two layers of uni-directional GRUs at the encoder and two layers of bi-directional GRUs at the decoder, with Nₙₑᵤᵣₒₙₛ=50 neurons at each GRU. We initialize each neuron in GRUs with U(−1/\sqrt{Nₙₑᵤᵣₒₙₛ}, 1/\sqrt{Nₙₑᵤᵣₒₙₛ}), and all the power weights and attention weights to 1.

The neural network encoder 116 and the neural network decoder 130 of the encoder-decoder architecture 400 are trained jointly as an autoencoder neural network using a plurality of training sample bit streams corresponding to a particular noise environment. In other words, the training is performed with particular forward/feedback noise powers and conduct inference in the same noise environment.

### 3.3 Modulo Approach for Longer Block Lengths

A direct application of the proposed coding architecture for long block lengths would be infeasible, since the larger input/output sizes of the encoder and decoder result in an exponential increase in complexity. Instead, we consider a modulo approach for processing a long block length of bits by successively applying our coding architecture created for short block lengths.

Particularly, in some embodiments, the processor 108 of the first communication device 102 divides a full bit stream b_{long} into a plurality of bit stream chunks b having a predetermined maximum number of bits K. The processor 108 performs the process for generating and transmitting the transmit signals x[k] for each bit stream chunk b of the plurality of bit stream chunks b.

We define the long block length as L (L>K), while K denotes the number of processing bits input to our coding architecture at a time. Formally, we denote the whole bit stream as b_{long}∈{0,1}^{L} and the index of the bit in b_{long} as [symbol] , [symbol] =0, . . . , L−1. We consider that our feedback coding architecture has been trained with block length K. To process the long block length, we divide the L bits into └L/K┘ chunks, and each chunk with length K is then processed with our coding architecture in a time-division manner. Formally, each chunk with length K can be represented with the modulo operation as [b_{long}[└ [symbol] /K┘], b_{long}[└ [symbol] /K┘+1], . . . , b_{long}[└ [symbol] /K┘+K−1]].

This modulo-based approach gives two distinct benefits. First, it reduces the complexity of the network structure by simplifying the encoding and decoding processes through successive applications of the neural network trained for a shorter block length. Second, it allows generalization across various block lengths (multiple of K bits) without necessitating re-training.

Note that our length-K coding architecture obtains a block length gain, but the modulo approach does not provide additional block length gain beyond the length-K trained neural network.

### 3.4 Computational Complexity Analysis

We first investigate the computational complexity of our length-K coding architecture for encoding/decoding K bits over N channel uses. We consider the number of layers of GRUs at the encoder and decoder as N_{e,layer} and N_{d,layer}, respectively. We assume that the same number of neurons, Nₑ and N_{d}, is used at each layer of the encoder and decoder. Then, the encoder and decoder of our approach will have computational complexities of

$$𝒪 ( {NN}_{e , layeτ} {N}_{e}^{2} + {NKN}_{e} ) and 𝒪 ( {NN}_{d , layeτ} {N}_{d}^{2} + {2}^{K} {N}_{d} ) ,$$

respectively. We then look into the complexity for encoding/decoding L (L>K) bits by using the length-K coding architecture based on the modulo approach discussed in Section 3.3. The corresponding complexities for encoding and decoding are

$$𝒪 ( ⌊ L / K ⌋ ( {NN}_{e , layeτ} {N}_{e}^{2} + {NKN}_{e} ) ) and 𝒪 ( ⌊ L / K ⌋ ( {NN}_{d , layeτ} {N}_{d}^{2} + {2}^{K} {N}_{d} ) ) ,$$

respectively.

Under Deepcode's architecture with a single layer of RNN at the encoder and two layers of bi-GRUs at the decoder, we obtain the big-O complexities of Deepcode to be

$$𝒪 ( {KN}_{e}^{2} ) and 𝒪 ( {KN}_{d}^{2} )$$

for encoding and decoding K bits, respectively. For encoding/decoding L (L>K) bits, the big-O complexities are

$$𝒪 ( L {N}_{e}^{2} ) and 𝒪 ( L {N}_{d}^{2} ) ,$$

respectively. For encoding/decoding K bits over N channel uses, the linear CL coding scheme only requires [symbol] (N²) and [symbol] (N) at the encoder and decoder, respectively. For processing L (L>K) bits with the CL scheme, the big-O complexities are [symbol] (└L/K┘N²) and [symbol] (└L/K┘N) at the encoder and decoder, respectively. On the other hand, for the error correction codes, decoding often imposes high computation overhead. The complexity of turbo coding generally increases faster than linearly with the block length L. For instance, the BCJR (Bahl-Cocke-Jelinek-Raviv) algorithm for turbo decoding typically has complexity of [symbol] (I(LN/K)²), where I is the number of iterations and usually larger than 10.

It is also important to note that the computations in our scheme can be parallelized, since (i) the encoding/decoding are mostly composed of matrix calculations and (ii) multiple chunks of K bits are processed in a time-division manner via the modulo approach. Overall, given the trade-off between performance and complexity, we can consider our feedback coding to improve the communication reliability at the expense of higher complexity compared with linear schemes and Deepcode.

### 4. Conclusion

In this work, we presented a new class of non-linear feedback codes that significantly increase robustness against channel noise via a RNN autoencoder architecture. Our learning architecture addressed the challenges of encoder-decoder separation over a noisy channel and inefficient power allocation. To overcome encoder-decoder separation, we processed the entire bit stream as a single unit to benefit from noise averaging, and adopted a bi-directional attention-based decoding architecture to fully exploit correlations among noisy receive signals. For power optimization, we introduced a power control layer at the encoder, and proved that the power constraint is satisfied asymptotically. Through numerical experiments, we demonstrated that under realistic forward/feedback noise regimes, our scheme outperforms state-of-the-art feedback codes significantly. We also provided information-theoretic insights on the power distribution of our non-linear feedback codes, showing that allocated power decreases over time. One other important observation we made is that canonical error correction codes still outperform feedback schemes when the feedback noise becomes high in a long block-length regime.

### Methods for Two-Way Communication Over an AWGN Channel

A variety of methods for two-way communication between the first communication device 102 and the second communication device 104 are discussed below. In the description of the method, statements that the method is performing some task or function refers to a controller or general-purpose processor (e.g., the processor 108 or the processor 120) executing programmed instructions stored in non-transitory computer readable storage media (e.g., the memory 110 or the memory 122) operatively connected to the controller or processor to manipulate data or to operate one or more components in the communication system 100 to perform the task or function. Additionally, the steps of the methods may be performed in any feasible chronological order, regardless of the order shown in the figures or the order in which the steps are described.

Although user cooperation cannot improve the capacity of Gaussian two-way channels (GTWCs) with independent noises, it can improve communication reliability. In this work, we aim to enhance and balance the communication reliability in GTWCs by minimizing the sum of error probabilities via joint design of encoders and decoders at the users. We first formulate general encoding/decoding functions, where the user cooperation is captured by the coupling of user encoding processes. The coupling effect renders the encoder/decoder design non-trivial, requiring effective decoding to capture this effect, as well as efficient power management at the encoders within power constraints. To address these challenges, we propose a two-way learning-based coding strategy. For learning-based coding, we introduce a recurrent neural network (RNN)-based coding architecture, where we propose interactive RNNs and a power control layer for encoding, and we incorporate bi-directional RNNs with an attention mechanism for decoding. Through simulations, we show that our two-way coding methodologies outperform conventional channel coding schemes (that do not utilize user cooperation) significantly in sum-error performance. We also demonstrate that our RNN-based coding performs best at low SNRs. We further investigate our two-way coding strategies in terms of power distribution, two-way coding benefit, different coding rates, and block-length gain.

To tackle the issues of linear processing, we further develop non-linear coding for GTWCs to provide higher degrees of flexibility in designing the codes.

In this disclosure, we aim to bridge the gaps between the two pieces of literature on GOWCs and GTWCs. The design of coding schemes for GTWCs faces the three following challenges.

(C-1) Coupling of user encoding processes. In GTWCs, each user generates a transmit symbol at each time step using its encoder. The encoding process utilizes its own message and the previously received symbols from the other user. Here, using the receive symbols as feedback information can enhance communication reliability, as demonstrated in feedback-enabled GOWCs. The generated transmit symbols are then exchanged between the users over time, resulting in a coupling effect in their encoding processes. This coupling intertwines the encoding and decoding operations of the users, ultimately affecting the overall system behavior.

(C-2) Requirement of effective decoding to capture the coupling effect. It is crucial for the decoding process at each user to effectively capture the coupling effect introduced by the encoders. This requirement necessitates a joint design of encoders and decoders for both users, adding complexity and posing a significant challenge in the design of decoders.

(C-3) Need for efficient power management within power constraints. Power management faces significant challenges due to the coupled encoding processes and the consideration of average power constraints for each user. Furthermore, when designing encoding schemes that utilize feedback information, power control over the sequence of transmit symbols becomes crucial for achieving robust error performance, as demonstrated in feedback-enabled GOWCs[8, 10, 14, 17]. Therefore, it is essential to incorporate an effective power control strategy into the encoder design for both users.

In light of the aforementioned challenges, we propose a two-way coding strategy for GTWCs: non-linear coding, which is inspired by recent advancements in deep learning. The major contributions of the disclosure are summarized below.

We first introduce a general functional form of encoding and decoding for two-way channels, where each user generates the transmit symbols by encoding both its own message and the past received symbols from the other user. Using the defined encoding/decoding functions, we then formulate an optimization problem for minimizing the sum of the error probabilities of the users under each user's power constraint, aiming to improve and balance the communication reliability in two-way channels.

We propose a learning-based coding architecture via RNN to capture the three aforementioned challenges of (C-1), (C-2), and (C-3). Specifically, to address (C-1), we construct a pair of interactive RNNs for encoding, where the previous output of one user's RNN is fed into the other user's RNN as a current input. The interactive RNNs effectively capture user cooperation in GTWCs through a utilization of RNNs, inspired by the successful application for feedback utilization in GOWCs[17]. To address (C-3), we introduce a power control layer at each user's encoder, which we prove satisfies all power constraints asymptotically. To address (C-2), we adopt bi-directional RNNs with an attention mechanism to fully exploit correlation among receive symbols, in which the encoders' coupling behavior is implicitly captured as a form of symbols. To address all these three challenges jointly in the coding architecture, we train the overall encoders/decoders at the users via auto-encoder.

Through numerical simulations, we show that our two-way coding strategy outperforms conventional channel coding schemes (that do not utilize user cooperation) by wide margins in terms of sum-error performance. RNN-based coding excels when either of the channel SNRs is low. For RNN-based coding, we observe that when the difference between the channel SNRs of the users is larger than some threshold, the user with higher channel SNR sacrifices some of its error performance to improve the other user's error performance, which in turn improves the sum-error performance. This behavior is consistent with the understanding presented in that a user with lower channel noise can function as a helper. We further provide information-theoretic insights on power distribution at the users, where RNN-based coding schemes allocate more power to early channel uses in asymmetric channels. This behavior is aligned with power distribution for feedback-enabled GOWCs. Lastly, we demonstrate that our coding schemes support higher coding rates and study the block-length gain of RNN-based coding.

We highlight the new contributions made in this work. For non-linear coding, we propose a new neural coding methodology based on deep learning. We conduct extensive performance evaluations, including sum-error performance, two-way coding benefits, varying coding rates, and block-length gain, as well as power distribution discussed with respect the one-way communication methods above.

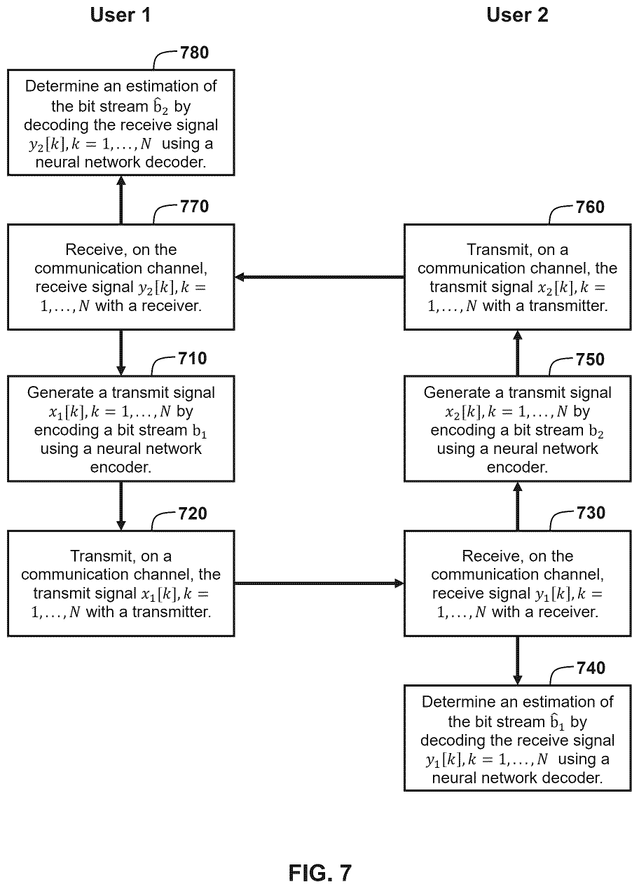

FIG. 7 shows a logical flow diagram for a method 700 for one-way communication between the first communication device 102 and the second communication device 104. At block 710, the processor 108 of the first communication device 102 (i.e., User 1) generates a transmit signal x₁[k], k=1, . . . , N by encoding a bit stream b₁ using the neural network encoder 116, where N is the number of timesteps during which the first communication device 102 and the second communication device 104 communicate. Next, at block 720, the processor 108 operates the transmitter 112 to transmit, on a first communication channel, the transmit signal x₁[k], k=1, . . . , N to the second communication device 102. Next, at block 730, the processor 120 of the second communication device 104 (i.e., User 2) operates the receiver 126 to receive a receive signal y₁[k], k=1, . . . , N corresponding to the transmit signal x₁[k], k=1, . . . , N with noise introduced in the first communication channel. Next, at block 740, the processor 120 determines an estimation of the bit stream \hat{b}₁ by decoding the receive signal y₁[k], k=1, . . . , N using the neural network decoder 130.

Additionally, at block 750, the processor 120 of the second communication device 104 generates a transmit signal x₂[k], k=1, . . . , N by encoding a bit stream b₂ using the neural network encoder 128. The processor 120 encodes the bit stream b₂ based at least in part on receive signal y₁[k], k=1, . . . , N. Next, at block 760, the processor 120 operates the transmitter 124 to transmit, on a second communication channel, a transmit signal x₂[k], k=1, . . . , N. Next, at step 770, the processor 108 of the first communication device 102 operates the receiver 114 to receive, on the second communication channel, a receive signal y₂[k], k=1, . . . , N corresponding to the transmit signal x₂[k], k=1, . . . , N with noise introduced in the second communication channel. Returning step 710, the processor 108 encodes the bit stream b₁ based at least in part on receive signal y₂[k], k=1, . . . , N. Finally, at block 780, the processor 108 determines an estimation of the bit stream \hat{b}₂ by decoding the receive signal y₂[k], k=1, . . . , N using the neural network decoder 118.

The technical details of the neural network architectures used to implement the method 700 are discussed in further detail below.

### II. System Model and Optimization Problem for Coding

In this section, we first present a transmission model for GTWCs in Sec. II-A. Then, we provide a general functional form of encoding and decoding at the users in Sec. II-B. Lastly, we formulate an optimization problem for sum-error minimization in Sec. II-C.

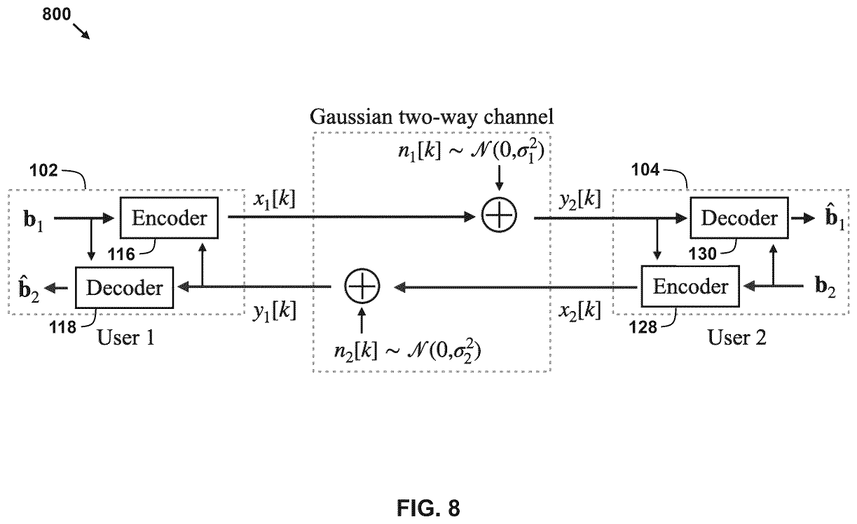

FIG. 8 shows a canonical system model 800 for two-way communication in an AWGN communication channel with noisy feedback. The goal is to successfully convey the messages bᵢ to each other by exchanging transmit symbols xᵢ[k] between the users. The users employ encoders and decoders to ensure successful message transmissions, where the two-way interaction between the users should be captured. This channel model is referred to as a GTWC.

### II-A. Transmission Model

We assume that transmission occurs over N channel uses (or timesteps). Let k∈{1, . . . , N} denote the channel use index, and x₁[k]∈ [symbol] and x₂[k]∈ [symbol] represent the transmit symbols of User 1 and User 2, respectively, at time k. Subsequently, the receive symbols at User 2 and User 1, respectively, at time k are given by

$${y}_{2} [ k ] = {x}_{1} [ k ] + {n}_{1} [ k ] ∈ ℝ , {y}_{1} [ k ] = {x}_{2} [ k ] + {n}_{2} [ k ] ∈ ℝ , \qquad ( 1 - 2 )$$

where

$${n}_{1} [ k ] ∼ 𝒩 ( 0 , {σ}_{1}^{2} ) and {n}_{2} [ k ] ∼ 𝒩 ( 0 , {σ}_{2}^{2} )$$

are Gaussian noises, which are independent of each other and across the channel use index k. We consider an average power constraint for transmission at the users as

$$𝔼 [ {\sum }_{k = 1}^{N} {x}_{i}^{2} [ k ] ] \leq NP , i ∈ \{ 1 , 2 \} , \qquad ( 2 - 2 )$$

where P denotes the average transmit power constraint per channel use at each user. The distribution of variables over which the expectation in equation (2-2) is taken will be specified in equation (6-2).

### II-B. Functional Form of Encoding and Decoding

The goal of exchanging transmit symbols among the users is to transmit a message available at each user to the other. As shown in FIG. 8, we consider that each User i, i∈{1,2}, aims to transmit a unique message represented by a bit vector, bᵢ∈{0,1}^{K}^{ᵢ}, to the other user, where Kᵢ is the number of source bits at User i. We first provide a general functional form of encoding and decoding at the users.

1) Encoding: User i encodes the bit vector bᵢ∈{0,1}^{K}^{ᵢ} to generate the N transmit symbols,

$${\{ {x}_{i} [ k ] \}}_{k = 1}^{N} .$$

The coding rate at User i is defined by rᵢ=Kᵢ/N. Rather than encoding the bit vector bᵢ solely to generate the transmit symbols

$${\{ {x}_{i} [ k ] \}}_{k = 1}^{N} ,$$

we consider a joint encoding scheme that leverages both the bit vector and the receive symbols in GTWCs. The utilization of receive (or feedback) symbols in generating transmit symbols has been demonstrated to effectively enhance communication reliability in feedback-enabled GOWCs[8, 10, 14, 17]. This observation inspires us to utilize feedback in the framework of GTWC encoding. In particular, at time k, the encoding at User i is described as a function of the bit vector bᵢ and the k−1 receive symbols

$${\{ {y}_{i} [ j ] \}}_{j = 1}^{k - 1}$$

in equation (1-2). We denote an encoding function of User i at time k as f_{i,k}: [symbol] ^{K}^{ᵢ}^{+k-1}→ [symbol] . We can subsequently represent the encoding of User i at time k as

$${x}_{i} [ k ] = {f}_{i , k} ( {b}_{i} , {y}_{i} [ 1 ] , … , {y}_{i} [ k - 1 ] ) , k = 1 , … , N . \qquad ( 3 - 2 )$$

The encoding functions {f_{i,k}}_{i,k} can be linear or non-linear depending on design choices. In this work, we address non-linear coding in Sec. III.

2) Decoding: Once the N transmissions are completed, Users 1 and 2 compute estimates of the bit vector of the other user, respectively, \hat{b}₂∈{0,1}^{K}^{₂} and \hat{b}₁∈{0,1}^{K}^{₁}. For decoding, User i can utilize the N receive symbols,

$${\{ {y}_{i} [ k ] \}}_{k = 1}^{N}$$

in equation (1-2), and its own bit vector bᵢ. Specifically, its own bit vector bᵢ can be used as side information for decoding at User i since the receive symbols

$${\{ {y}_{i} [ k ] \}}_{k = 1}^{N}$$

contain not only the other user's bit vector information but also its own bit vector information due to the causal encoding processes in equation (3-2) and the subsequent symbol exchange in equation (1-2). We denote the decoding functions of User 1 and 2 as g₁: [symbol] ^{N+K}^{₁}→{0,1}^{K}^{₂} and g₂: [symbol] ^{N+K}^{₂}→{0,1}^{K}^{₁}, respectively. We can then represent the decoding processes conducted by User 1 and User 2, respectively, as

$${\hat{b}}_{2} = {g}_{1} ( {b}_{1} , {y}_{1} [ 1 ] , ... , {y}_{1} [ N ] ) , {\hat{b}}_{1} = {g}_{2} ( {b}_{2} , {y}_{2} [ 1 ] , ... , {y}_{2} [ N ] ) . \qquad ( 4 - 2 )$$

The decoding functions {gᵢ}ᵢ can be either linear or non-linear. We address non-linear coding in Sec. III.

### II-C. Optimization of Encoders and Decoders

Since our goal is to design practical codes with finite block-lengths, we consider error probability as our main performance indicator. To quantify the error probability, we consider two different metrics of interest. The first metric is block error rate (BLER), which is the ratio of the number of incorrect bit vectors to the total number of bit vectors. Formally, the BLER of User i's bit vector is defined as BLERᵢ=Pr[{bᵢ≠\hat{b}ᵢ}], i∈{1,2}. The other metric is bit error rate (BER), which is the ratio of the number of incorrect bits to the total number of bits in bit vectors. We first represent the [symbol] -th entry of bᵢ and \hat{b}ᵢ as bᵢ[ [symbol] ]∈{0,1} and \hat{b}ᵢ[ [symbol] ]∈{0,1}, respectively. Then, the BER of bᵢ[ [symbol] ] is defined by [symbol] =Pr[{bᵢ[ [symbol] ]≠\hat{b}ᵢ[ [symbol] ]}], i∈{1,2} and [symbol] ∈{1, . . . , Kᵢ}. It is worth noting that BER values can differ for each individual bit entry, i.e., [symbol] ≠BER_{i,m} for [symbol] ≠m, depending on the design of encoding/decoding functions in equations (3-2)-(4-2). To achieve the goal of minimizing BERs across all entries, our objective is to minimize the average BER over all entries. Formally, we define the average BER of User i's bit vector as

$${BER}_{i} = ( 1 / {K}_{i} ) {\sum }_{ℓ = 1}^{{K}_{i}} {BER}_{i , ℓ} = ( 1 / {K}_{i} ) {\sum }_{ℓ = 1}^{{K}_{i}} Pr [ \{ {b}_{i} [ ℓ ] \neq {\hat{b}}_{i} [ ℓ ] \} ] .$$

In this work, we assume that all bits in b₁ and b₂ are independent and identically distributed (i.i.d.) to one another.

For generalization, we assume User i uses an error probability metric denoted by

$${ε}_{i} ( {\{ {f}_{1 , k} \}}_{k = 1}^{N} , {\{ {f}_{2 , k} \}}_{k = 1}^{N} , {g}_{\overline{i}} , P , {σ}_{1}^{2} , {σ}_{2}^{2} , {K}_{1} , {K}_{2} , N ) ,$$

which can represent either BLERᵢ or BERᵢ depending on design choices. Here, ī denotes the index of the counterpart of User i, i.e., ī=2 if i=1 while ī=1 if i=2. In this work, we aim to design the encoding and decoding functions when the values of

$$P , {σ}_{1}^{2} , {σ}_{2}^{2} , {K}_{1} , {K}_{2} ,$$

and N are given. We thus simplify the dependency as

$${ε}_{i} ( {\{ {f}_{1 , k} \}}_{k = 1}^{N} , {\{ {f}_{2 , k} \}}_{k = 1}^{N} , {g}_{\overline{i}} ) .$$

The objective in this work is to minimize the error probability of both users, while balancing the communication reliability in two-way channels. Accordingly, we formulate the following optimization problem:

$${minimize}_{{\{ {f}_{1 , k} \}}_{k = 1}^{N} , {\{ {f}_{2 , k} \}}_{k = 1}^{N} , {g}_{1} , {g}_{2}} {ε}_{1} ( {\{ {f}_{1 , k} \}}_{k = 1}^{N} , {\{ {f}_{2 , k} \}}_{k = 1}^{N} , {g}_{2} ) + {ε}_{2} ( {\{ {f}_{1 , k} \}}_{k = 1}^{N} , {\{ {f}_{2 , k} \}}_{k = 1}^{N} , {g}_{1} ) \qquad ( 5 - 2 )$$

$$subject to {𝔼}_{{b}_{1} , {b}_{2} , {n}_{1} , {n}_{2}} [ {\sum }_{k = 1}^{N} {x}_{i}^{2} [ k ] ] \leq NP , i ∈ \{ 1 , 2 \} , \qquad ( 6 - 2 )$$

where nᵢ=[nᵢ[1], . . . , nᵢ[N]]^{T}, i∈{1,2}. The expectation in equation (6-2) is taken over the distributions of the bit vectors, b₁ and b₂, and the noise terms, n₁ and n₂; the transmit symbol xᵢ[k] in equation (6-2) is the encoding output as a function of its local bit vector bᵢ and the receive symbols, yᵢ[1], . . . , yᵢ[k−1], shown in equation (3-2). The receive symbols, yᵢ[1], . . . , yᵢ[k−1], are dependent on the noises n₁ and n₂ and the other user's encoding process, i.e., the bit vector of the other user

$${b}_{\overline{i}} ,$$

through the successive encoding operation of the both users as shown in equations (1-2) and (3-2).

Solving equations (5-2)-(6-2) is non-trivial and challenging since the encoding processes of both the users (in equation (3-2)) are coupled to each other in a causal manner, and the coupling effect should be incorporated into the design of the encoders/decoders of both users. To address these challenges, we propose a distinct two-way coding approach. To allow higher degrees of freedom for coding, we propose a non-linear coding approach based on deep learning in Sec. III.

### III. Learning-Based Coding via RNNs

In this section, we propose a non-linear coding methodology based on deep learning frameworks which allow higher degrees of freedom in coding. First, we adopt a state propagation-based encoding (Sec. III-A), and then, we discuss the composition of our learning-based coding structure in two parts: encoding (Sec. III-B) and decoding (Sec. III-C). Afterwards, we discuss how to train our coding architecture and how to make an inference (Sec. III-D), and finally in Sec. III-E, we discuss a modulo-based approach to process long block-lengths of bits with the proposed RNN-based coding architecture.

### III-A. State Propagation-Based Encoding

Recall the optimization problem of equations (5-2)-(6-2), where the design variables are 2N different encoding functions:

$${\{ {f}_{1 , k} \}}_{k = 1}^{N} and {\{ {f}_{2 , k} \}}_{k = 1}^{N} ,$$

and two decoding functions, g₁ and g₂. It is expected that the N encoding functions at each user are correlated with one another, since the inputs used for encoding at each timestep in equation (3-2) overlap. Based on the correlation of encoding processes across time, we adopt a state

propagation-based encoding technique [17], where only two functions are used for encoding at each user: (i) signal-generation and (ii) state-propagation. By designing only these two functions instead of the N encoding functions, the design complexity for encoding could be significantly reduced.

We first define the signal-generation function of User i as fᵢ: [symbol] ^{K}^{ᵢ}^{+N}^{ₛ}⁺¹→ [symbol] . We then re-write the encoding process in equation (3-2) as

$${x}_{i} [ k ] = {f}_{i} ( {b}_{i} , {y}_{i} [ k - 1 ] , {s}_{i} [ k ] ) , k ∈ \{ 1 , ... , N \} , \qquad ( 55 - 2 )$$

where we assume y₁[0]=0. Here, sᵢ[k]∈ [symbol] ^{N}^{ₛ} is the state vector, which propagates over time through the state-propagation function hᵢ: [symbol] ^{K}^{ᵢ}^{+N}^{ₛ}⁺¹→ [symbol] ^{N}^{ₛ}, which is given by

$${s}_{i} [ k ] = {h}_{i} ( {b}_{i} , {y}_{i} [ k - 1 ] , {s}_{i} [ k - 1 ] ) , k ∈ \{ 1 , ... , N \} . \qquad ( 56 - 2 )$$

In equation (56-2), the current state sᵢ[k] is updated from the prior state sᵢ[k−1] by incorporating bᵢ and yᵢ[k−1]. For the initial condition, we assume sᵢ[0]=0. We note that the functional form xᵢ[k]=f_{i,k}(bᵢ, yᵢ[1], . . . , yᵢ[k−1]) in equation (3-2) is represented by the two equations (55-2) and (56-2); The current state vector sᵢ[k] as an input in equation (55-2) is a function of the previous state sᵢ[k−1] in (56-2), where sᵢ[k−1] contains yᵢ[k−2] as an input. By the recursive nature of the function hᵢ in equation (56-2), all previous receive signals, yᵢ[1], . . . , yᵢ[k−1] are captured for encoding as in equation (3-2). This encoding model in equations (55-2)-(56-2) can be seen as a general and non-linear extension of the state-space model used for linear encoding in feedback-enabled systems[12].

By using this technique, we only need to construct two encoding functions for each User i, fᵢ and hᵢ—instead of N distinct functions

$${\{ {f}_{i , k} \}}_{k = 1}^{N}$$

in equation (3-2)—and the decoding function gᵢ. We thus re-write the optimization problem in equations (5-2)-(6-2) as

$${minimize}_{{f}_{1} , {f}_{2} , {h}_{1} , {h}_{2} , {g}_{1} , {g}_{2}} {ε}_{1} ( {f}_{1} , {f}_{2} , {h}_{1} , {h}_{2} , {g}_{2} ) + {ε}_{2} ( {f}_{1} , {f}_{2} , {h}_{1} , {h}_{2} , {g}_{1} ) \qquad ( 57 - 2 )$$

$$subject to {𝔼}_{{b}_{1} , {b}_{2} , {n}_{1} , {n}_{2}} [ {\sum }_{k = 1}^{N} {x}_{i}^{2} [ k ] ] \leq NP , i ∈ \{ 1 , 2 \} , \qquad ( 58 - 2 )$$

where the dependency on the error probability εᵢ, i∈{1,2}, has been modified from equations (5-2) to (57-2) for state propagation-based encoding.

The problem of equations (57-2)-(58-2) is still non-trivial since the encoding/decoding functions, fᵢ, hᵢ, and gᵢ, can take arbitrary forms. A proper design of such non-linear functions can potentially provide higher degrees of flexibility in encoders' and decoders' behavior. To design such non-linear functions, in this section, we develop a learning-based coding architecture, which will be discussed in two parts: encoding (Sec. III-B) and decoding (Sec. III-C).

### III-B. Encoding

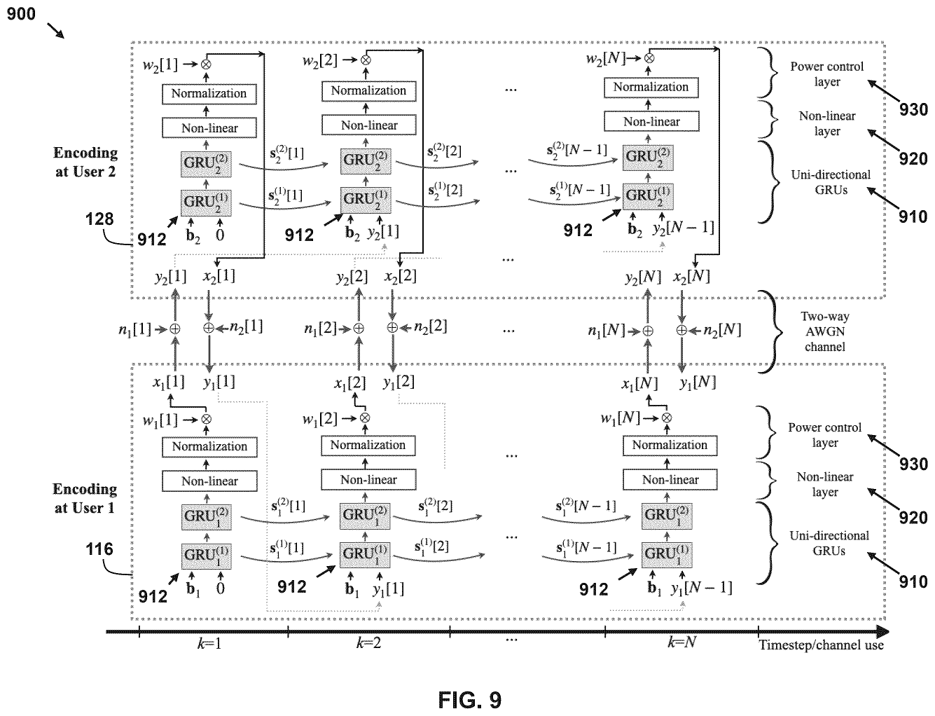

FIG. 9 shows an encoder architecture 900 for two-way communication between the first communication device 102 and the second communication device 104. The encoder architecture 900 includes the neural network encoder 116 and the neural network encoder 128. In the encoder architecture 900, the neural network encoder 116 and the neural network encoder 128 each includes at least one recurrent neural network layer 910, a non-linear neural network layer 920, and at least one power control neural network layer 930.

We follow the state propagation-based encoding approach discussed in Sec. III-A. The concept of state propagation over time motivates us to employ RN Ns as components of our learning architecture, similar to [17]. Specifically, we utilize gated recurrent units (GRUs), a type of RNNs, to effectively capture the long-term dependency of time-series information [26]. For User i, i∈{1,2}, the state-propagation function hᵢ in equation (56-2) consists of two layers of GRUs, while the signal-generation function fᵢ in equation (55-2) consists of a non-linear layer and a power control layer in sequence.

1) GRUs for state propagation: The at least one recurrent neural network layer 910 has a plurality of recurrent neural network cells 912 in a forward arrangement. In the illustrated embodiment, each recurrent neural network cell 112 is a gated recurrent unit (GRU) cell. However, it should be appreciated that other types of cells may be utilized, such as Long Short-Term Memory (LSTM) cells. The plurality of recurrent neural network cells 912 are configured to receive the bit stream b₁ or b₂ and the receive signal y₁[k] or y₂[k] as input. The plurality of recurrent neural network cells 912 are configured to output a final state vector based on the bit stream b₁ or b₂ and the receive signal y₁[k] or y₂[k].

Particularly, at each time step, the following procedure is conducted for a total of N time steps, where N transmit signals are generated for transmission over the N channel uses. First, the input to the first layer of the forward recurrent neural network cells 912 is the K bits of the bit stream b₁ or b₂, the receive signal y₁[k] or y₂[k], and the previous state vector of the first layer of the forward recurrent neural network cells 912, and the output from the first layer is the current state vector of the first layer. Next, the input to the second layer is the current state vector of the first layer and the previous state vector of the second layer, and the output from the second layer is the current state vector of the second layer. If more than two layers are considered, the rest of the layers higher than the second layer follows the same steps for the second layer as described as above. Finally, the output of the last layer of the forward recurrent neural network cells 912 is the final state vector that is used as input to the non-linear neural network layer 920.

We adopt two layers of unidirectional GRUs at each user to capture the time correlation of the receive signals in a causal manner. Formally, we represent the input-output relationship at each layer at time k at User i as

$${s}_{i}^{( 1 )} [ k ] = {GRU}_{i}^{( 1 )} ( {b}_{i} , {y}_{i} [ k - 1 ] , {s}_{i}^{( 1 )} [ k - 1 ] ) , \qquad ( 59 - 2 )$$

$${s}_{i}^{( 2 )} [ k ] = {GRU}_{i}^{( 2 )} ( {s}_{i}^{( 1 )} [ k ] , {s}_{i}^{( 2 )} [ k - 1 ] ) , \qquad ( 60 - 2 )$$

where

$$G R {U}_{i}^{( ℓ )}$$

represents a functional form of GRU processing at layer [symbol] of User i and

$${s}_{i}^{( ℓ )} [ k ] ∈ {ℝ}^{{N}_{i , ℓ}^{( enc )}}$$

is the state vector obtained by

$$G R {U}_{i}^{( ℓ )}$$

at time k, where i∈{1,2}, [symbol] ∈{1,2}, and k∈{1, . . . , N}. For the initial conditions, we assume

$${s}_{i}^{( ℓ )} [ 0 ] = 0 , i ∈ \{ 1 , 2 \} ,$$

[symbol]

∈{1,2}.

Equations (59-2)-(60-2) can be represented as a functional form of the state propagation-based encoding in equation (56-2). By defining the overall state vector as

$${s}_{i} [ k ] = [ {s}_{i}^{( 1 )} [ k ] , {s}_{i}^{( 2 )} [ k ] ] , \qquad ( 1 )$$

we obtain sᵢ[k]=hᵢ(bᵢ, yᵢ[k−1], sᵢ[k−1]), where hᵢ denotes the process of two layers of GRUs in equations (59-2)-(60-2). Note that sᵢ[k] propagates over time through the GR Us by incorporating the current input information into its state. Because the bit vector bᵢ with length Kᵢ is handled as a block to generate transmit signals with any length N, our method is flexible enough to support any coding rate rᵢ=Kᵢ/N. Furthermore, the GRUs are interactive between the users since each user's GRU incorporates the previously received symbol as input, as shown in FIG. 9. The pair of interactive GRUs effectively captures the interplay of the users' encoding processes.

2) Non-linear layer: The non-linear neural network layer 920 is configured to receive the final state vector from the at least one recurrent neural network layer 910, apply a linear operation to the first state vector with a non-linear activation function, and output a scalar vector \tilde{x}ᵢ[k]. Particularly, at each time step, the following procedure is conducted for a total of N time steps, where N transmit signals are generated for transmission over the N channel uses. First, the input to the non-linear neural network layer 920 is the final state vector obtained from one or more layers of forward recurrent neural network cells 912. The input undergoes linear processing, wherein a vector input is multiplied by a trainable weight vector w_{enc,i} using an inner product operation, followed by adding a trainable scalar bias value b_{enc,i} to the outcome of the inner product. The scalar value after the linear processing goes through a non-linear activation function, e.g., hyperbolic tangent, resulting in another scalar value \tilde{x}ᵢ[k] as an output.

We adopt an additional non-linear layer at the output of the GRUs. The state vector at the last layer of the GRUs, i.e.,

$${s}_{i}^{( 2 )} [ k ] ,$$

is taken as an input to this additional non-linear layer. Formally, we can represent the process of the non-linear layer at User i as

$${\tilde{x}}_{i} [ k ] = ϕ ( {w}_{enc , i}^{T} {s}_{i}^{( 2 )} [ k ] + {b}_{enc , i} ) , k ∈ \{ 1 , … , N \} , \qquad ( 61 - 2 )$$

where

$${w}_{e n c , i} ∈ {ℝ}^{{N}_{i , 2}^{( enc )}}$$

and b_{enc,i}∈ [symbol] are the trainable weights and biases, respectively, and ϕ: [symbol] → [symbol] is an activation function. In this work, we employ the hyperbolic tangent for ϕ[26].

Since \tilde{x}[k] (as the output of the hyperbolic tangent) ranges in (−1,1), it is possible to use a scaled version of \tilde{x}[k], i.e., \sqrt{P}\tilde{x}[k], as a transmit symbol that satisfies the power constraint

$${{Σ}_{k = 1}^{N} ( \sqrt{P} \tilde{x} [ k ] )}^{2} \leq NP .$$

However, this does not ensure maximum or efficient utilization of the transmit power budget. Power control over the sequence of transmit signals is essential in the design of encoding schemes using feedback signals in order to achieve robust error performance, e.g., in feedback-enabled communications[8, 10, 14, 17].

3) Power control layer: The at least one power control neural network layer 930 is configured to receive the scalar vector \tilde{x}ᵢ[k], multiply the scalar vector \tilde{x}ᵢ[k] with a weights vector wᵢ[k], and output the transmit signal x[k]. Particularly, at each time step, the following procedure is conducted for a total of N time steps, where N transmit signals are generated for transmission over the N channel uses. First, the scalar vector \tilde{x}[k] obtained from the non-linear neural network layer 920 serves as the input, which then undergoes normalization comprising subtracting the sample mean and dividing by the sample variance, both of which are trainable. Subsequently, the normalized value is multiplied by a trainable scalar weights vector wᵢ[k].

We introduce a power control layer to optimize for the power distribution, while satisfying the power constraint in equation (58-2). This layer consists of two sequential modules: normalization and power-weight multiplication. The transmit symbol of User i at time k is then generated by

$${x}_{i} [ k ] = {w}_{i} [ k ] {γ}_{i , k}^{( J )} ( {\tilde{x}}_{i} [ k ] ) , k ∈ \{ 1 , … , N \} , \qquad ( 62 - 2 )$$

where wᵢ[k] is a trainable power weight satisfying

$${Σ}_{k = 1}^{N} {w}_{i}^{2} [ k ] = N P , i ∈ \{ 1 , 2 \} ,$$

$$and$$

$${γ}_{i , k}^{( J )} : ℝ \to ℝ$$

is a normalization function applied to \tilde{x}ᵢ[k] in a form of

$${γ}_{i , k}^{( J )} ( x ) = ( x - {m}_{i , k} ( J ) ) / {d}_{i , k} ( J ) .$$

Here, m_{i,k}(J) and

$${d}_{i , k}^{2} ( J )$$

are the sample mean and sample variance of x at User i at time k calculated from the data with size J.

Through the power control layer, the power weights {wᵢ[k]}_{i,k} are optimized via training in a way that minimizes the sum of errors in equation (57-2). At the same time, the power constraint in equation (58-2) should be satisfied. However, satisfying the power constraint in an (ensemble) average sense is non-trivial because the distributions of

$${\{ {x}_{i} [ k ] \}}_{k = 1}^{N}$$

are unknown. Therefore, we approach it in an empirical sense as adopted in [17]: (i) During training, we use standard batch normalization; we normalize \tilde{x}ᵢ[k] with the sample mean and sample variance calculated from each batch of data with size N_{batch} at each k. Note that N_{batch} denotes the size of batch used in a single iteration during training, and J represents the total available training data. (ii) After training, we calculate and save the sample mean m_{i,k}(J) and sample variance

$${d}_{i , k}^{2} ( J )$$

from the entire training data with size J. (iii) For inference, we use the saved mean and variance for normalization.

In the following lemma, we show that the above procedure guarantees satisfaction of the equality power constraint in an asymptotic sense with a large number of training data used for normalization.

Lemma 2. Given the power control layer at User i in equation (62-2), the power constraint in equation (58-2) converges to NP almost surely, i.e.,

$${𝔼}_{{b}_{1} , {b}_{2} , {n}_{1} , {n}_{2}} [ {Σ}_{k = 1}^{N} {x}_{i}^{2} [ k ] ] {\to }^{a . s .} NP ,$$

as the number of training data J used for the normalization in equation (62-2) tends to infinity.

### III-C. Decoding

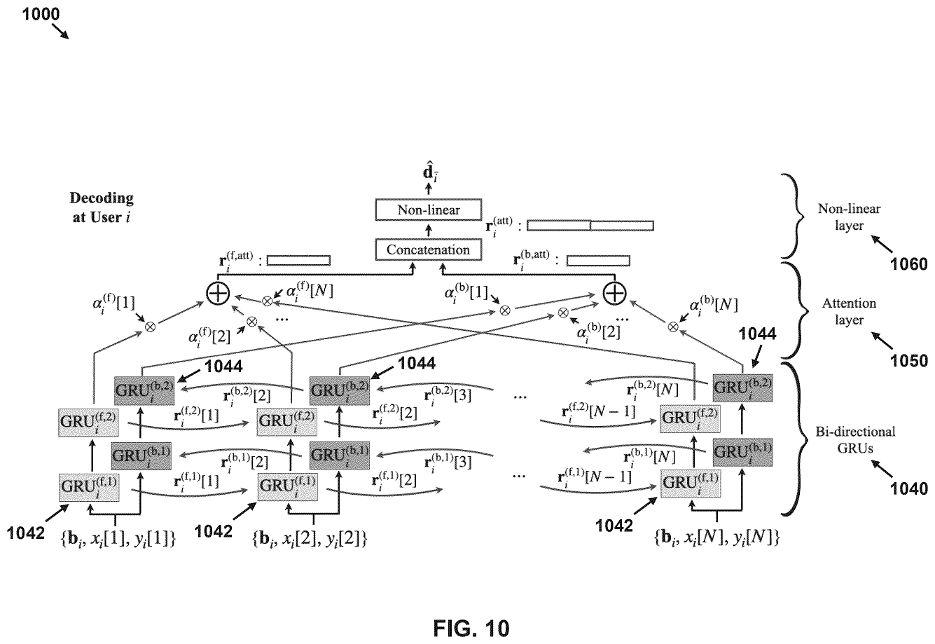

FIG. 10 shows a decoder architecture 1000 for two-way communication between the first communication device 102 and the second communication device 104. The decoder architecture 1000 includes the neural network decoder 118 and the neural network decoder 130. In the decoder architecture 1000, the neural network decoder 118 and the neural network decoder 130 each includes at least one recurrent neural network layer 1040, an attention layer 1050, and a non-linear neural network layer 1060.

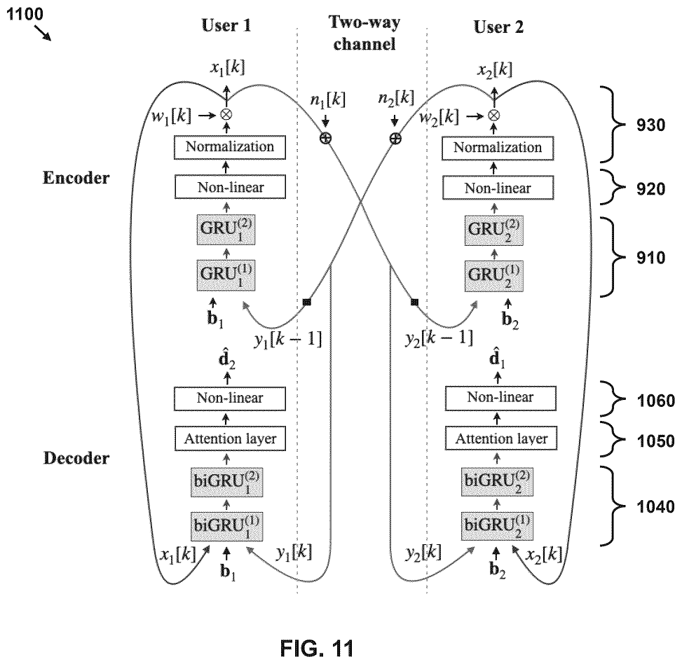

FIG. 11 shows a compact version of an encoder-decoder architecture 1000 that omits detailed illustration of the timesteps seen in FIG. 9 and FIG. 10.

We follow the state propagation-based decoding approach discussed in Sec. III-B. Bi-directional RNNs with the attention mechanism are introduced to exploit correlations among receive symbols in which the encoders' coupling behavior is captured. Here, ī denotes the index of the counterpart of User i, i.e., ī=2 if i=1 while ī=1 if i=2. The decoding function gᵢ for User i in equation (4-2) consists of bi-directional GRUs, an attention layer, and a non-linear layer in sequence. We discuss each of them in detail below.

1) Bi-directional GRUs: The at least one recurrent neural network layer 1040 has a plurality of recurrent neural network cells 1042 in a forward arrangement and a plurality of recurrent neural network cells 1044 in a backward arrangement. In the illustrated embodiment, each recurrent neural network cell 1042, 1044 is a gated recurrent unit (GRU) cell. However, it should be appreciated that other types of cells may be utilized, such as Long Short-Term Memory (LSTM) cells. The plurality of recurrent neural network cells 1042 are configured to receive the receive signal yᵢ[k] as input and output a final forward state vector. The plurality of recurrent neural network cells 1044 are configured to receive the receive signal yᵢ[k] as input and output a final backward state vector.

Particularly, at each time step, the following procedure is conducted for a total of N time steps, where N transmit signals are generated for transmission over the N channel uses. First, the input to the first layer of the forward recurrent neural network cells 1042 is the current receive signal yᵢ[k], the transmit signal xᵢ[k] from encoder of the same device, the bit stream bᵢ to be sent by the same device, and previous state vector of the first layer of the forward recurrent neural network cells 1042, and the output is the current state vector of the first layer of the forward recurrent neural network cells 1042. The input to the first layer of the backward recurrent neural network cells 1044 is the current receive signal yᵢ[k], the transmit signal xᵢ[k] from encoder of the same device, the bit stream bᵢ to be sent by the same device, and the next-step state vector of the first layer of the backward recurrent neural network cells 1044, and the output is the current state vector of the first layer of the backward recurrent neural network cells 1044. Next, the input to the second layer of the forward recurrent neural network cells 1042 is the current state vector of the first layer of the forward recurrent neural network cells 1042 and the previous state vector of the second layer of the forward recurrent neural network cells 1042. The input to the second layer of the backward recurrent neural network cells 1044 is the current state vector of the first layer of the backward recurrent neural network cells 1044 and the next-step state vector of the second layer of the backward recurrent neural network cells 1044. If more than two layers are considered, the rest of the layers higher than the second layer follows the same steps for the second layer as described as above. The output of the last layer of the forward recurrent neural network cells 1042 and backward recurrent neural network cells 1044 are the final forward state vector and the final backward state vector, respectively.

At each user, we utilize two layers of bi-directional GRUs to capture the time correlation of the receive symbols both in the forward and backward directions over the sequence of the receive symbols. We represent the input-output relationship of the forward directional GRUs at time k of User i as

$${r}_{i}^{( f , 1 )} [ k ] = {GRU}_{i}^{( f , 1 )} ( {b}_{i} , {x}_{i} [ k ] , {y}_{i} [ k ] , {r}_{i}^{( f , 1 )} [ k - 1 ] ) , \qquad ( 63 - 2 )$$

$$and {r}_{i}^{( f , 2 )} [ k ] = {GRU}_{i}^{( f , 2 )} ( {r}_{i}^{( f , 1 )} [ k ] , {r}_{i}^{( f , 2 )} [ k - 1 ] ) ,$$

and that of the backward directional GRUs as

$${r}_{i}^{( b , 1 )} [ k ] = {GRU}_{i}^{( b , 1 )} ( {b}_{i} , {x}_{i} [ k ] , {y}_{i} [ k ] , {r}_{i}^{( b , 1 )} [ k + 1 ] ) , \qquad ( 64 - 2 )$$

$$and {r}_{i}^{( b , 2 )} [ k ] = {GRU}_{i}^{( b , 2 )} ( {r}_{i}^{( b , 1 )} [ k ] , {r}_{i}^{( b , 2 )} [ k + 1 ] ) ,$$

where

$${GRU}_{i}^{( f , ℓ )} and {GRU}_{i}^{( b , ℓ )}$$

represent functional forms of GRU processing at layer [symbol] of User i in the forward and backward direction, respectively. Here,

$${r}_{i}^{( f , ℓ )} [ k ] ∈ {ℝ}^{{N}_{i , ℓ}^{( dec )}} and {r}_{i}^{( b , ℓ )} [ k ] ∈ {ℝ}^{{N}_{i , ℓ}^{( dec )}}$$

are the state vectors obtained by

$${GRU}_{i}^{( f , ℓ )} and {GRU}_{i}^{( b , ℓ )} ,$$

respectively, at time k, where i∈{1,2}, [symbol] ∈{1,2}, and k∈{1, . . . , N}. For the initial conditions,

$${r}_{i}^{( f , ℓ )} [ 0 ] = 0 and {r}_{i}^{( b , ℓ )} [ N + 1 ] = 0 ,$$

where i∈{1,2} and [symbol] ∈{1,2}.

2) Attention layer: The attention layer 1050 is configured to receive the final forward state vector and the final backward state vector from the at least one recurrent neural network layer 1040. Next, the attention layer 1050 determines an attention-processed forward state vector

$${r}_{i}^{( f , att )}$$

based on the final forward state vector and forward attention weights

$${α}_{i}^{( f )} .$$

Likewise, the attention layer 1050 determines an attention-processed backward state vector

$${r}_{i}^{( b , att )}$$

based on the final backward state vector and backward attention weights

$${α}_{i}^{( b )} .$$

Particularly, at each time step, the following procedure is conducted for a total of N time steps, where N transmit signals are generated for transmission over the N channel uses. First, the input to the attention layer 1050 is the final N forward state vectors and the final N backward state vectors, both of which are obtained over the N time steps. Next, the final N forward state vectors are multiplied by trainable forward attention weights α_{f,k} and then summed to produce an attention-processed forward state vector

$${r}_{i}^{( f , att )}$$

as an output. The final N backward state vectors are multiplied by trainable backward attention weights α_{b,k} and then summed to produce an attention-processed backward state vector

$${r}_{i}^{( b , att )}$$

as an output.

We consider the forward/backward state vectors at the last layer, i.e.,

$${\{ {r}_{i}^{( f , 2 )} [ k ] \}}_{k = 1}^{N} and {\{ {r}_{i}^{( b , 2 )} [ k ] \}}_{k = 1}^{N} ,$$

as inputs to the attention layer. Each state vector contains different feature information depending on both its direction and timestep k: the forward state vector

$${r}_{i}^{( f , 2 )} [ k ]$$

captures the implicit correlation information of the input tuples of the previous timesteps, i.e., {bᵢ, xᵢ[1], yᵢ[1]}, . . . , {bᵢ, xᵢ[k], yᵢ[k]}, while the backward state vector

$${r}_{i}^{( b , 2 )} [ k ]$$

captures that of the later timesteps, i.e., {bᵢ, xᵢ[k], yᵢ[k]}, . . . , {bᵢ, xᵢ[N], yᵢ[N]}. Although the state vectors at each end, i.e.,

$${r}_{i}^{( f , 2 )} [ N ] and {r}_{i}^{( b , 2 )} [ 1 ] ,$$

contain the information of all input data tuples, the long-term dependency cannot be fully captured [27]. Therefore, we adopt the attention layer [28], which merges the state vectors in the form of a summation. Formally,

$${r}_{i}^{( f , att )} = {\sum }_{k = 1}^{N} {α}_{i}^{( f )} [ k ] {r}_{i}^{( f , 2 )} [ k ] ∈ {ℝ}^{{N}_{i , 2}^{( dec )}} , and {r}_{i}^{( b , att )} = {\sum }_{k = 1}^{N} {α}_{i}^{( b )} [ k ] {r}_{i}^{( b , 2 )} [ k ] ∈ {ℝ}^{{N}_{i , 2}^{( dec )}} , \qquad ( 65 - 2 )$$

where

$${α}_{i}^{( f )} [ k ] ∈ ℝ and {α}_{i}^{( b )} [ k ] ∈ ℝ$$

are the trainable attention weights applied to the forward and backward state vectors, respectively, k∈{1, . . . , N}. We capture the forward and backward directional information separately by concatenating the two vectors as

$${r}_{i}^{( att )} = [ {r}_{i}^{( f , att )} ; {r}_{i}^{( b , att )} ] ∈ {ℝ}^{2 {N}_{i , 2}^{( dec )}} . \qquad ( 66 - 2 )$$

The attention mechanism enables the decoder at User i to fully capture the interaction between the two users over noisy channels by exploiting all timesteps' data tuples

$${\{ {b}_{i} , {x}_{i} [ k ] , {y}_{i} [ k ] \}}_{k = 1}^{N} .$$

3) Non-linear layer: The non-linear neural network layer 1060 is configured to receive the combined state vector

$${r}_{i}^{( att )} .$$

Next, the non-linear neural network layer 1060 applies a linear operation to the combined state vector

$${r}_{i}^{( att )}$$

with a non-linear activation function and outputs the estimation of the bit stream

$${\hat{b}}_{\overline{i}} .$$

Particularly, the single combined state vector is multiplied with a trainable weight matrix W_{dec,i} and then added to a trainable bias vector v_{dec,i}, resulting in an output vector with length M. Next, for M=2^{K}, the output vector goes through a softmax function, resulting in an output that is the probability distribution of 2^{K} possible outcomes of the bit stream with length K, ensuring block-wise processing. Finally, for M=K, the output vector goes through a sigmoid function, resulting in an output where each entry of the output vector denotes the probability of the binary outcome between 0 or 1 of each bit, ensuring bit-wise processing.

We utilize a non-linear layer to finally obtain the estimate of the other user's bit

$${\hat{b}}_{\overline{i}} ,$$

vector by using the combined state vector

$${r}_{i}^{( att )}$$

in equation (66-2), where ī denotes the index of the counterpart of User i, i.e., ī=2 if i=1 while ī=1 if i=2. The input-output relationship at the non-linear layer is given by

$${\hat{d}}_{\overline{i}} = θ ( {W}_{dec , i} {r}_{i}^{( att )} + {v}_{dec , i} ) ∈ {( 0 , 1 )}^{{M}_{\overline{i}}} \qquad ( 67 - 2 )$$

where

$${w}_{dec , i} ∈ {ℝ}^{{M}_{\overline{i}} \times 2 {N}_{i , 2}^{( dec )}} and {v}_{dec , i} ∈ {ℝ}^{{M}_{\overline{i}}}$$

are the trainable weights and biases, respectively, and θ:

$${ℝ}^{{M}_{\overline{i}}} \to {ℝ}^{{M}_{\overline{i}}}$$

is an activation function.

The dimension

$${M}_{\overline{i}}$$

and the activation function θ are chosen differently depending on the performance metric of interest. When BLER is considered for a metric, we utilize the softmax activation function and set

$${M}_{\overline{i}} = {2}^{{K}_{\overline{i}}} .$$

### Then

$${\hat{d}}_{\overline{i}}$$

in equation (67-2) denotes the probability distribution of

$${2}^{{K}_{\overline{i}}}$$

possible outcomes of

$${\hat{b}}_{\overline{i}} .$$

Since the softmax function allows for classification with multiple classes, we can minimize the block error of the bit vectors, i.e., Pr[{bᵢ≠\hat{b}ᵢ}], by treating each possible outcome of bᵢ as a class. For example, if bᵢ∈{0,1}², there are four possible classes, [0,0], [0,1], [1,0], and [1,1]. On the other hand, when BER is considered for a metric, we consider the sigmoid activation function and set

$${M}_{\overline{i}} = {K}_{\overline{i}} ,$$

where each entry of

$${\hat{d}}_{\overline{i}}$$

denotes the probability distribution of each entry of

$${\hat{b}}_{\overline{i}} .$$

Since the sigmoid function allows classification for binary classes, we can minimize the error of each bit, i.e., Pr[{bᵢ[ [symbol] ]≠\hat{b}ᵢ[ [symbol] ]}], by conducting binary classification for each bit.

### III-D. Training and Inference

1) Model training: We consider different loss functions depending on the performance metric of interest. When BLER is considered for a metric, we have adopted the softmax function for multi-class classification, discussed in Sec. III-C3. The commonly used loss function for training with the softmax function is cross-entropy (CE) loss. This loss function has been demonstrated to be effective in terms of the performance of multi-class classification tasks[26]. Therefore, for sum-BLER minimization, we consider the sum of CE loss defined by

$${ℒ}_{sum - BLER} = {\sum }_{i = 1}^{2} CE ( {d}_{i} , {\hat{d}}_{i} ) = - {\sum }_{i = 1}^{2} {\sum }_{ℓ = 1}^{{2}^{{K}_{i}}} {d}_{i} [ ℓ ] log {\hat{d}}_{i} [ ℓ ] , \qquad ( 68 - 2 )$$

where dᵢ[ [symbol] ] and \hat{d}ᵢ[ [symbol] ] are the [symbol] -th entry of dᵢ∈{0,1}²^{^{K}}^{ᵢ} and \hat{d}ᵢ∈(0,1)²^{^{K}}^{ᵢ}, respectively. Here, dᵢ is the target vector, which is a one-hot representation of bᵢ∈{0,1}^{K}^{ᵢ}. That is, only one entry of dᵢ has a value of 1, while the rest entries are zero. Note that \hat{d}ᵢ is the inference output from the softmax function in equation (67-2). By treating the entire bit vector as a block through the use of one-hot vectors, we transform our problem of minimizing sum-BLER, i.e.

$${\sum }_{i = 1}^{2} Pr [ \{ {b}_{i} \neq {\hat{b}}_{i} \} ] ,$$

into a block-level classification problem.

On the other hand, when BER is considered for a metric, we have adopted the sigmoid function for binary classification, discussed in Sec. III-C3. Binary cross-entropy (BCE) loss is a commonly used loss function for training with sigmoid function and has been shown to be effective for binary classification. [26]. Therefore, for sum-BER minimization, we consider the sum of binary cross entropy (BCE) loss defined by

$${ℒ}_{sum - BLER} = {\sum }_{i = 1}^{2} BCE ( {b}_{i} , {\hat{d}}_{i} ) = - {\sum }_{i = 1}^{2} {\sum }_{ℓ = 1}^{{K}_{i}} ( {b}_{i} [ ℓ ] log ( {\hat{d}}_{i} [ ℓ ] ) + ( 1 - {b}_{i} [ ℓ ] ) log ( 1 - {\hat{d}}_{i} [ ℓ ] ) ) , \qquad ( 69 - 2 )$$

where bᵢ[ [symbol] ]∈{0,1} is the [symbol] -th entry of bᵢ∈{0,1}^{K}^{ᵢ}. Note that \hat{d}ᵢ∈(0,1)^{K}^{ᵢ} denotes the sigmoid output from equation (67-2). By treating each bit for training, we convert our problem of minimizing sum-BER, i.e.,

$${\sum }_{i = 1}^{2} ( 1 / {K}_{i} ) {\sum }_{ℓ = 1}^{{K}_{i}} Pr [ ( \{ {b}_{i} [ ℓ ] \neq {\hat{b}}_{i} [ ℓ ] \} ) ] ,$$

to a bit-level classification problem.

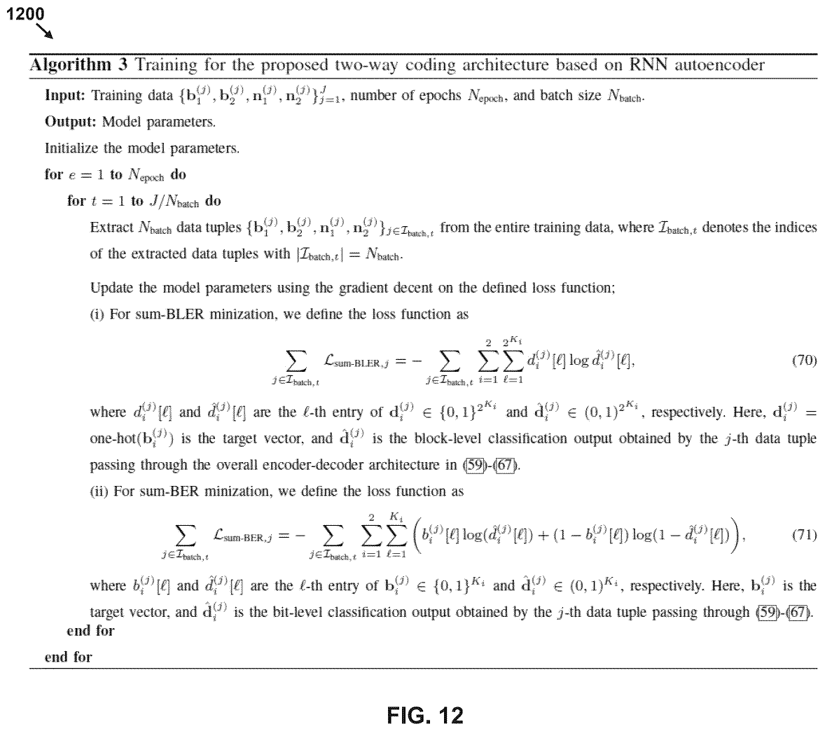

FIG. 12 shows pseudocode 1200 for an exemplary algorithm for training the proposed two-way coding architecture based on RNN autoencoder. Either for sum-BLER or sum-BER minimization, we jointly train the encoders and decoders of both the users via autoencoder.

2) Inference: Once the coding architecture is trained, the goal of the decoder at each User i is to recover the other user's bit vector

$${\hat{b}}_{\overline{i}} ∈ {\{ 0 , 1 \}}^{{K}_{\overline{i}}}$$

from the decoding output

$${\hat{d}}_{\overline{i}}$$

in equation (67-2). We note that the recovery process is different depending on the performance metric of interest. First, for sum-BLER minimization, User i forces the entry with the largest value of

$${\hat{d}}_{\overline{i}} ∈ {( 0 , 1 )}^{{2}^{{K}_{\overline{i}}}}$$

to 1, while setting the rest of the entries to 0, and then maps the obtained one-hot vector to a bit vector, which is then

$${\hat{b}}_{\overline{i}} .$$

For sum-BER minimization, User i obtains

$${\hat{b}}_{\overline{i}}$$

by rounding each entry of

$${\hat{d}}_{\overline{i}} ∈ {( 0 , 1 )}^{{K}_{\overline{i}}}$$

to be either 0 or 1. That is,

$${\hat{b}}_{\overline{i}} [ ℓ ]$$

is a rounded version of

$${\hat{d}}_{\overline{i}} [ ℓ ] .$$

Thus, in some embodiments, during inference, the processor 120 of the second communication device 104 decoding the receive signal to determine a one-hot vector

$${\hat{b}}_{\overline{i}}$$

having only a single non-zero value and determines the estimation of a bit stream \hat{b} as the single non-zero value from the one-hot vector

$${\hat{d}}_{\overline{i}} ,$$

Thus, for M=2^{K}, which corresponds to block-wise processing, the entry with the largest value is converted to have an output of 1, while the rest of the entries are converted to 0, resulting in a one-hot vector

$${\hat{d}}_{\overline{i}}$$

where only 1 non-zero value in the 2^{K}-length vector. In such embodiments, the processor 108, 120 decodes the receive signal to determine the one-hot vector

$${\hat{d}}_{\overline{i}}$$

having only a single non-zero value and the processor 108, 120 determines the estimation of a bit stream

$${\hat{b}}_{\overline{i}}$$

as the single non-zero value from the one-hot vector

$${\hat{d}}_{\overline{i}} .$$

The one-hot vector is mapped to a bit stream vector of length K, which is the final recovered K bits.

Alternatively, for M=K, which corresponds to bit-wise processing, if each entry's value is larger than 0.5, the value is mapped to 1, otherwise 0, resulting in a K-length binary vector, which is the final recovered K bits of the estimation of a bit stream \hat{b}_{ī}.

### III-E. Modulo-Based Approach for Long Block-Lengths

A direct application of the proposed coding architecture for long block-lengths is not feasible, since the larger input/output sizes of the encoders and decoders result in a substantial increase in complexity. In particular, the larger input/output sizes lead to an increased number of computations at the non-linear layer in the decoder (in equation (67-2)) and potentially larger state vector sizes at the encoder (in equations (59-2)-(60-2)) and the decoder (in equations (63-2)-(64-2)), aiming to capture hidden features from the input data. To address this issue, we consider a modulo approach for processing long block-lengths of bits by successively applying our coding architecture built for short block-lengths.

In the long block-length regime, we define the entire block-length at User i as Lᵢ>Kᵢ, while Kᵢ denotes the number of processing bits input to our coding architecture at a time, i∈{1,2}. We consider that our two-way coding architecture has been trained for block-lengths K₁ and K₂, i.e., for conveying K₁ bits from User 1 to 2 and K₂ bits from User 2 to 1 over N channel uses. To process the entire block-length L₁ at User 1 and L₂ at User 2, each User i first divides the Lᵢ bits into ┌Lᵢ/Kᵢ┐ chunks each with length Kᵢ. Note that when Lᵢ is not a multiple of Kᵢ, we can simply pad zeros following the residual bits in the last chunk. Then, the two users exchange their signals to convey their chunks of K₁ and K₂ bits by using our coding architecture in a time-division manner.

This modulo-based approach provides two benefits. First, it reduces the complexity of the network architecture by simplifying the encoding and decoding processes through successive applications of the neural networks trained for shorter block-lengths. Second, it allows generalization across various block-lengths (multiple of Kᵢ bits) without necessitating re-training.

### IV. Computational Complexity of RNN-Based Coding

We next investigate the computational complexity for RNN-based coding. In Algorithm 3, we obtain the model parameters for the non-linear coding architecture depicted in FIG. 11. The constructed architecture is then used for encoding and decoding with the fixed model parameters without further training. Although we implemented two layers of GRUs at the encoder (in FIG. 9) and decoder (in FIG. 10), we consider a general numbers of layers for complexity analysis, and define the number of GRU layers at the encoder and decoder of User i as

$${N}_{i}^{( enc , lay )} and {N}_{i}^{( dec , lay )} ,$$

respectively. Accordingly, we denote the number of neurons at each GRU layer at the encoder and decoder of User i as

$${N}_{i}^{( e n c )} and {N}_{i}^{( d e c )} ,$$

respectively, assuming the same number of neurons is applied to each GRU layer. For encoding, User i has the complexity of

$$𝒪 ( {NN}_{i}^{( e n c )} ( {N}_{i}^{( e n c )} {N}_{i}^{( enc , lay )} + {K}_{i} ) ) .$$

For decoding, User i has the complexity of

$$𝒪 ( {N}_{i}^{( dec , lay )} {N ( {N}_{i}^{( d e c )} )}^{2} + {K}_{\overline{i}} N {N}_{i}^{( d e c )} )$$

when the sigmoid function is used, while it has

$$𝒪 ( {N}_{i}^{( dec , lay )} {N ( {N}_{i}^{( d e c )} )}^{2} + {K}_{\overline{i}} N {N}_{i}^{( d e c )} + {2}^{{K}_{\overline{i}}} {N}_{i}^{( d e c )} )$$

when the softmax function is used, where ī denotes the index of the counterpart of User i, i.e., ī=2 if i=1 while ī=1 if i=2.

The encoding and decoding complexity at the users for RNN-based coding are summarized in Table I. The RNN-based coding causes higher encoding/decoding complexity, it benefits from higher degrees of flexibility thanks to the non-linearity provided by deep neural networks, leading to better error performance under many practical noise scenarios.

TABLE I

| | User i, i ∈ {1, 2} |
|---|---|
| Encoder | [symbol] (NNᵢ^{(enc)} (Nᵢ^{(enc)} Nᵢ^{(enc,lay)} + Kᵢ)) |
| Decoder with sigmoid | [symbol] (Nᵢ^{(dec,lay)} N (Nᵢ^{(dec)})² + [symbol] NNᵢ^{(dec)}) |
| Decoder with softmax | [symbol] (Nᵢ^{(dec,lay)} N (Nᵢ^{(dec)})² + [symbol] NNᵢ^{(dec)} + |
| | 2 [symbol] Nᵢ^{(dec)}) |

### V. Conclusion

In this work, we focused on balancing the communication reliability between the two users in GTWCs by minimizing the sum of error probabilities of the users through the design of encoders/decoders for the users. W e first provided general encoding/decoding functions and formulated an optimization problem, aiming to minimize the sum-error of the users subject to users' power constraints. We proposed learning-based coding to address the challenges of (i) the encoders' coupling effect, (ii) the requirement for effective decoding, and (iii) the need for efficient power management.

For learning-based coding, we proposed an RNN-based coding architecture composed of multiple advantageous components. For encoding, we proposed interactive RNNs for addressing challenge (i) and a power control layer for addressing challenge (iii), while for decoding, we incorporated bi-directional RNNs with an attention mechanism for addressing challenge (ii). To jointly address these challenges, we trained the encoders/decoders via an autoencoder. We then analyzed the computational complexity of both our linear and non-linear coding schemes.

Embodiments within the scope of the disclosure may also include non-transitory computer-readable storage media or machine-readable medium for carrying or having computer-executable instructions (also referred to as program instructions) or data structures stored thereon. Such non-transitory computer-readable storage media or machine-readable medium may be any available media that can be accessed by a general-purpose or special-purpose computer. By way of example, and not limitation, such non-transitory computer-readable storage media or machine-readable medium can comprise RAM, ROM, EEPROM, CD-ROM or other optical disk storage, magnetic disk storage or other magnetic storage devices, or any other medium which can be used to carry or store desired program code means in the form of computer-executable instructions or data structures. Combinations of the above should also be included within the scope of the non- transitory computer-readable storage media or machine-readable medium.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected.

What is claimed is:

1. A method for communicating between a first device and a second device, the method comprising:
generating a first transmit signal by encoding a first bit stream with a first processor of the first device, the first bit stream being encoded using a first neural network encoder;
transmitting, on a first communication channel, the first transmit signal to the second device with a first transmitter of the first device;
receiving, on the first communication channel, a first receive signal with a second receiver of the second device, the first receive signal corresponding to the first transmit signal with noise introduced in the first communication channel; and
determining an estimation of the first bit stream by decoding the first receive signal with a second processor of the second device, the first receive signal being decoded using a second neural network decoder.

2. The method according to claim 1 further comprising:
transmitting, on a second communication channel, a second transmit signal to the first device with a second transmitter of the second device; and
receiving, on the second communication channel, a second receive signal with a first receiver of the first device, the second receive signal corresponding to the second transmit signal with noise introduced in the second communication channel,
wherein the generating the first transmit signal includes encoding the first bit stream based on the second receive signal.

3. The method according to claim 2, the transmitting the second transmit signal including:
transmitting the first receive signal as the second transmit signal.

4. The method according to claim 2 further comprising:
generating the second transmit signal by encoding a second bit stream with the second processor of the second device, the second bit stream being encoded using a second neural network encoder; and
determining an estimation of the second bit stream by decoding the second receive signal with the first processor of the first device, the second receive signal being decoded using a second neural network decoder,
wherein the generating the second transmit signal includes encoding the second bit stream based on the first receive signal.

5. The method according to claim 4, wherein:
the determining the estimation of the first bit stream includes decoding the first receive signal based on the second bit stream and based on the second transmit signal; and
the determining the estimation of the second bit stream includes decoding the second receive signal based on the first bit stream and based on the first transmit signal.

6. The method according to claim 1, wherein the first neural network encoder and the second neural network decoder are trained jointly as an autoencoder neural network using a plurality of training sample bit streams corresponding to a particular noise environment.

7. The method according to claim 1, wherein the first neural network encoder includes:
at least one first recurrent neural network layer having a first plurality of recurrent neural network cells in a forward arrangement, the first plurality of recurrent neural network cells being configured to receive the first bit stream as input and output a first state vector; and
the first neural network encoder includes a first non-linear neural network layer configured to receive the first state vector, apply a linear operation to the first state vector with a non-linear activation function, and output a first scalar vector, the first transmit signal being determined at least in part based on the first scalar vector.

8. The method according to claim 7, wherein:
the first neural network encoder includes at least one further neural network layer configured to (i) receive the first scalar vector, (ii) multiply the first scalar vector with a weights vector, and (iii) output the first transmit signal; and
the weights vector is learned during a training of the first neural network encoder such that the first transmit signal satisfies a power constraint of the first transmitter of the first device.

9. The method according to claim 1, wherein the second neural network decoder includes:
at least one second recurrent neural network layer having a second plurality of recurrent neural network cells in a forward arrangement and a third plurality of recurrent neural network cells in a backward arrangement, the second plurality of recurrent neural network cells being configured to receive the first receive signal as input and output a second state vector, the third plurality of recurrent neural network cells being configured to receive the first receive signal as input and output a third state vector;
an attention layer configured to (i) receive the second state vector and the third state vector, (ii) determine an attention-processed second state vector based on the second state vector and first attention weights, and (iii) determine an attention-processed third state vector based on the third state vector and second attention weights;
a concatenation layer determines a combined state vector by concatenating the attention-processed second state vector and the attention-processed third state vector; and
a second non-linear neural network layer configured to receive the combined state vector, apply a linear operation to the combined state vector with a non-linear activation function, and output the estimation of the first bit stream.

10. A method for transmitting data from a first device to a second device, the method comprising:
generating a first transmit signal by encoding a first bit stream with a processor of the first device, the first bit stream being encoded using a neural network encoder; and
transmitting, on a first communication channel, the first transmit signal to the second device with a transmitter of the first device,
wherein the neural network encoder includes:
at least one recurrent neural network layer having a plurality of recurrent neural network cells in a forward arrangement, the plurality of recurrent neural network cells being configured to receive the first bit stream as input and output a state vector; and
a non-linear neural network layer configured to receive the state vector, apply a linear operation to the state vector with a non-linear activation function, and output a scalar vector, the first transmit signal being determined at least in part based on the scalar vector.

11. The method according to claim 10, wherein:
the neural network encoder includes at least one further neural network layer configured to (i) receive the scalar vector, (ii) multiply the scalar vector with a weights vector, and (iii) output the first transmit signal; and
the weights vector is learned during a training of the neural network encoder such that the first transmit signal satisfies a power constraint of the first transmitter of the first device.

12. The method according to claim 10 further comprising:
receiving, on a second communication channel, a feedback signal with a first receiver of the first device, the feedback signal corresponding to a receive signal received and transmitted by the second device with noise introduced in the second communication channel,
wherein the generating the first transmit signal includes encoding the first bit stream based on second receive signal.

13. The method according to claim 12 further comprising:
receiving, on a second communication channel, a receive signal with a first receiver of the first device, the receive signal corresponding to a second transmit signal transmitted by the second device with noise introduced in the second communication channel; and
determining an estimation of a second bit stream by decoding the second receive signal with the processor of the first device, the receive signal being decoded using a neural network decoder.

14. The method according to claim 13, wherein the determining the estimation of the second bit stream includes decoding the receive signal based on the first bit stream and based on the first transmit signal.

15. The method according to claim 10, further comprising:
dividing the first bit stream into a plurality of chunks having a predetermined maximum number of bits,
wherein (i) the generating the first transmit signal and (ii) the transmitting the first transmit signal are respectively performed for each for each chunk of the plurality of chunks.

16. A method for recovering data received with a second device from a first device, the method comprising:
receiving, on a first communication channel, a receive signal with a receiver of the second device, the receive signal corresponding to a first transmit signal transmitted by the first device with noise introduced in the first communication channel; and
determining an estimation of a first bit stream by decoding the receive signal with a processor of the second device, the receive signal being decoded using a neural network decoder,
wherein the neural network decoder include:
at least one recurrent neural network layer having a first plurality of recurrent neural network cells in a forward arrangement and a second plurality of recurrent neural network cells in a backward arrangement, the first plurality of recurrent neural network cells being configured to receive the receive signal as input and output a first state vector, the second plurality of recurrent neural network cells being configured to receive the receive signal as input and output a second state vector;
an attention layer configured to (i) receive the first state vector and the second state vector, (ii) determine an attention-processed first state vector based on the first state vector and first attention weights, and (iii) determine an attention-processed second state vector based on the second state vector and second attention weights;
a concatenation layer determines a combined state vector by concatenating the attention-processed first state vector and the attention-processed second state vector; and
a second non-linear neural network layer configured to receive the combined state vector, apply a linear operation to the combined state vector with a non-linear activation function, and output the estimation of the first bit stream.

17. The method according to claim 16 further comprising:
transmitting, on a second communication channel, a second transmit signal to the first device with a transmitter of the second device, the receive signal being transmitted as the second transmit signal.

18. The method according to claim 16 further comprising:
generating a second transmit signal by encoding a second bit stream with the processor of the second device, the second bit stream being encoded using a neural network encoder and based on the receive signal; and
transmitting, on a second communication channel, the second transmit signal to the first device with a transmitter of the second device.

19. The method according to claim 18, wherein the determining the estimation of the first bit stream includes decoding the receive signal based on the second bit stream and based on the second transmit signal.

20. The method according to claim 16, the determining the estimation of a first bit stream comprising:
decoding the receive signal to determine a one-hot vector having only a single non-zero value; and
determining the estimation of a first bit stream as the single non-zero value from the one-hot vector.
